(19) United States
(12) Patent Application Publication
(10) Pub. No.: US 2021/0117973 A1
(43) Pub. Date: Apr. 22, 2021

(54) SYSTEMS AND METHODS FOR PAYMENT MANAGEMENT

(71) Applicant: BEIJING DIDI INFINITY TECHNOLOGY AND DEVELOPMENT CO., LTD., Beijing (CN)

(72) Inventor: Jiannan LV, Beijing (CN)

(73) Assignee: BEIJING DIDI INFINITY TECHNOLOGY AND DEVELOPMENT CO., LTD., Beijing (CN)

(21) Appl. No.: 17/082,058

(22) Filed: Oct. 28, 2020

Related U.S. Application Data
(63) Continuation of application No. PCT/CN2019/075961, filed on Feb. 22, 2019.

(30) Foreign Application Priority Data
May 16, 2018 (CN) 201810467961.1
Jun. 4, 2018 (CN) 201810562977.0

(51) Int. Cl. G06Q 20/40; G06Q 20/08; G06Q 20/32; G06F 16/29; G06F 21/60; G06F 16/903

(52) U.S. Cl. CPC G06Q 20/405; G06Q 20/085; G06Q 20/3224; G06Q 2220/00; G06F 16/29; G06F 21/602; G06F 16/90344; G06Q 20/4015

(57) ABSTRACT

Systems and methods for payment management are provided. The methods may include receiving a payment request including information related to a service provided by a service provider. The information related to the service may include first geographical information of the service provider. The methods may further include obtaining second geographical information of a location where the service is provided, and comparing the first geographical information and the second geographical information. The methods may further include determining whether the payment request is approved according to a preset rule at least based on the result of the comparison of the two geographical information.

### CROSS-REFERENCE TO RELATED APPLICATIONS

This application is a continuation of International Application No. PCT/CN2019/075961 filed on Feb. 22, 2019, which claims priority of Chinese Patent Application No. 201810467961.1, filed on May 16, 2018, and Chinese Patent Application No. 201810562977.0, filed on Jun. 4, 2018, the entire contents of each of which are hereby incorporated by reference in their entirety.

### TECHNICAL FIELD

The present disclosure generally relates to systems and methods for payment management, and in particular, to systems and methods for determining whether to approve a payment request.

### BACKGROUND

Many companies have a large amount of expenses to be reimbursed by their employees every month. It is a tedious and arduous task for companies to identify the authenticity of the expenses, make statistics on these expense payments, and set appropriate payment standards. It is a problem to be solved for the companies to perform the identification, statistics and standardization of these payment tasks electronically. When a company performs a reimbursement, it is often difficult to verify the authenticity of a corresponding reimbursement item, which may result in many unnecessary reimbursement expenses. At the same time, the employee may have to deal with different reimbursement items by himself/herself, in case that there is no complete and standardized process for someone else to represent the employee and deal with the reimbursement items for the employee, which may take much time of the employee. Moreover, when a service is provided to a user, a payment request may be initiated to pay for the service. If the payment request can be evaluated in a quick and secure way, it may bring much convenience for the user. Therefore, it is desirable to provide more efficient systems and methods for the management of payments.

### SUMMARY

According to an aspect of the present disclosure, a payment management method is provided. The payment management method may be implemented on a computing device having at least one processor and at least one non-transitory storage medium. The payment management method may include receiving a payment request and a relevant consumption evidence corresponding to a consumption event. The consumption evidence may include location information of an entity that provides the consumption evidence. The payment management method may further include obtaining a location where the consumption event occurs. The payment management method may further include, in response to a determination that the location information is uncorrelated to the location where the consumption event occurs, determining not to execute the payment.

In some embodiments, the determination that the location information is uncorrelated to the location where the consumption event occurs may include determining a first character string of the location information and a second character string of the location where the consumption event occurs and determining an overlapping ratio between the first character string and the second character string. The determination that the location information is uncorrelated to the location where the consumption event occurs may further include, in response to a determination that the overlapping ratio is less than a preset probability, determining that the location information is uncorrelated to the location where the consumption event occurs.

In some embodiments, the determination that the location information is uncorrelated to the location where the consumption event occurs may include determining a first region related to the location information and a second region related to the location where the consumption event occurs and determining an overlapping area between the first region and the second region. The determination that the location information is uncorrelated to the location where the consumption event occurs may further include, in response to a determination that the overlapping area is less than a preset area, determining that the location information is uncorrelated to the location where the consumption event occurs.

In some embodiments, in response to a determination that the location information is correlated to the location where the consumption event occurs, the payment management method may further include determining a consumption category of the relevant consumption evidence. The payment management method may further include, in response to a determination that a dwell time related to the location where the consumption event occurs is less than a preset time duration corresponding to the consumption category, determining not to execute the payment.

According to another aspect of the present disclosure, a payment management system is provided. The payment management system may include an information receiving unit. The information receiving unit may be configured to receive a payment request and a relevant consumption evidence corresponding to a consumption event. The consumption evidence may include location information of an entity that provides the consumption evidence. The payment management system may further include a location obtaining unit. The location obtaining unit may be configured to obtain a location where the consumption event occurs. The payment management system may further include a determination unit. The determination unit may be configured to, in response to a determination that the location information is uncorrelated to the location where the consumption event occurs, determine not to execute the payment.

According to yet another aspect of the present disclosure, a computing device is provided. The computing device may include a storage, a processor, and computer programs stored in the storage and executable by the processor. When executing the computer programs, the processor may effectuate the fore-mentioned payment management method.

According to still another aspect of the present disclosure, a computer readable storage medium is provided. The computer readable storage medium may store computer programs. When executed by the processor, the computer programs may effectuate the fore-mentioned payment management method.

According to yet another aspect of the present disclosure, a fee payment management method is provided. The fee payment management method may be implemented on a computing device having at least one processor and at least one non-transitory storage medium. The fee payment management method may include receiving a first fee payment request related to a second user initiated by a first user, determining at least one piece of consumption information corresponding to the fee payment request, and verifying the at least one piece of consumption information. The fee payment management method may further include verifying whether the first user may be authorized to initiate the fee payment request related to the second user. The fee payment management method may further include, in response to a determination that the at least one piece of consumption information is verified and the first user may be authorized to initiate the fee payment request related to the second user, allocating a fee corresponding to the at least one piece of consumption information to an account of the second user based on the fee payment request.

In some embodiments, the fee payment management method may further include determining a time difference between a time point when the fee payment request initiated by the first user may be received and a time point when a fee payment request initiated by the second user is received. The fee payment management method may further include, in response to a determination that the time difference is not greater than a preset time, determining the at least one piece of consumption information based on the fee payment request initiated by the second user.

In some embodiments, the fee payment management method may further include, in response to a determination that the at least one piece of consumption information is verified and the first user is authorized to initiate the fee payment request related to the second user, deleting information of at least one first user corresponding to the second user and any fee payment request of the at least one first user.

In some embodiments, the verifying the at least one piece of consumption information may include determining at least one consumption parameter related to the at least one piece of consumption information, and determining a matching degree of each of the at least one consumption parameter based on a consumption system database storing the at least one piece of consumption information. The verifying the at least one piece of consumption information may further include, in response to a determination that all of the at least one matching degree is greater than at least one corresponding matching threshold, determining that the at least one piece of consumption information may be successfully verified. The verifying the at least one piece of consumption information may further include, in response to a determination that not all of the at least one matching degree is greater than the at least one corresponding matching threshold, determining that the at least one piece of consumption information fails to be verified. The at least one consumption parameter may include one or more of a consumption time, a consumption location, and a consumption category.

According to another aspect of the present disclosure, a fee payment management system is provided. The fee payment management system may include a request receiving unit configured to receive a first payment request including first information related to a service provided to a second user. The fee payment management system may further include an information verification unit configured to determine at least one piece of consumption information corresponding to the fee payment request and verify the at least one piece of consumption information. The fee payment management system may further include a proxy verification unit, configured to verify whether the first user may be authorized to initiate the fee payment request related to the second user. The fee payment management system may further include an execution unit. The execution unit may be configured to, in response to a determination that the at least one piece of consumption information is verified and the first user is authorized to initiate the fee payment request related to the second user, allocate a fee corresponding to the at least one piece of consumption information to an account of the second user based on the fee payment request.

According to still another aspect of the present disclosure, a computing device is provided. The computing device may include a storage, a processor, and computer programs stored in the storage and executable by the processor. When executing the computer programs, the processor may effectuate the fore-mentioned fee payment management method.

According to yet another aspect of the present disclosure, a computer readable storage medium is provided. The computer readable storage medium may store computer programs. When executed by the processor, the computer programs may effectuate the fore-mentioned fee payment management method.

According to still another aspect of the present disclosure, a system is provided. The system may include at least one storage medium including a set of instructions, and at least one processor in communication with the at least one storage medium, wherein when executing the instructions, the at least one processor may be configured to direct the system to perform operations including receiving a payment request including information related to a service provided by a service provider. The information related to the service may include first geographical information of the service provider. The at least one processor may be further configured to direct the system to perform operations including obtaining second geographical information of a location where the service is provided, comparing the first geographical information and the second geographical information, and determining whether the payment request may be approved according to a preset rule at least based on the result of the comparison of the two geographical information.

In some embodiments, the service may be paid for by the user via a terminal device, and the second geographical information may be generated by a positioning transceiver component of the terminal device.

In some embodiments, the second geographical information may include a prescribed geographical location.

In some embodiments, the first geographical information of the service provider may include a geographical location of an entity of the service provider.

In some embodiments, the first geographical information may include a first character string, and the second geographical information may include a second character string. To determine whether the payment request may be approved according to the preset rule at least based on the result of the comparison of the two geographical information, the at least one processor may be configured to direct the system to perform additional operations including determining a similarity between the first character string and the second character string.

In some embodiments, the preset rule may include, in response to a determination that the similarity between the first character string and the second character string exceeds a similarity threshold, determining that the payment request is approved.

In some embodiments, the first geographical information may include a first geographical location, and the second geographical information may include a second geographical location. To determine whether the payment request is approved according to the preset rule at least based on the result of the comparison of the two geographical information, the at least one processor may be configured to direct the system to perform additional operations including determining a correlation between the first geographical location and the second geographical location.

In some embodiments, to determine whether the payment request is approved according to the preset rule at least based on the result of the comparison of the two geographical information, the at least one processor may be configured to direct the system to perform additional operations including determining a first region including the first geographical location and a second region including the second geographical location. The at least one processor may be further configured to direct the system to perform additional operations including determining the correlation between the first geographical location and the second geographical location based on an overlap between the first region and the second region.

In some embodiments, the preset rule may include comparing the overlap between the first region and the second region with an overlap threshold. The preset rule may further include, in response to the result of the comparison that the overlap between the first region and the second region exceeds an overlap threshold, determining that the payment request is approved.

In some embodiments, to determine whether the payment request is approved according to the preset rule at least based on the result of the comparison of the two geographical information, the at least one processor may be configured to direct the system to perform additional operations including determining a time duration related to the service.

In some embodiments, the preset rule may include comparing the time duration related to the service with a time threshold. The preset rule may further include, in response to the result of the comparison that the time duration related to the service exceeds a time threshold, determining that the payment request is approved.

In some embodiments, the payment request may be encrypted, and the at least one processor may be further configured to direct the system to perform additional operations including decrypting the payment request.

According to still another aspect of the present disclosure, a method is provided. The method may be implemented on a computing device having at least one processor and at least one non-transitory storage medium. The method may include receiving a payment request including information related to a service provided by a service provider. The information related to the service may include first geographical information of the service provider. The method may further include obtaining second geographical information of a location where the service is provided, and comparing the first geographical information and the second geographical information. The method may further include determining whether the payment request is approved according to a preset rule at least based on the result of the comparison of the two geographical information.

According to yet another aspect of the present disclosure, a system may include an obtaining module. The obtaining module may be configured to receive a payment request including information related to a service provided by a service provider, the information related to the service may include first geographical information of the service provider. The obtaining module may be further configured to obtain second geographical information of a location where the service is provided. The system may further include a determination module. The determination module may be configured to compare the first geographical information and the second geographical information. The system may determine whether the payment request is approved according to a preset rule at least based on the result of the comparison of the two geographical information.

According to still another aspect of the present disclosure, a non-transitory computer readable medium is provided. The non-transitory computer readable medium may include at least one set of instructions. When executed by at least one processor, the at least one set of instructions may direct the at least one processor to effectuate a method. The method may include receiving a payment request including information related to a service provided by a service provider. The information related to the service may include first geographical information of the service provider. The method may further include obtaining second geographical information of a location where the service is provided, and comparing the first geographical information and the second geographical information. The method may further include determining whether the payment request is approved according to a preset rule at least based on the result of the comparison of the two geographical information.

According to yet another aspect of the present disclosure, a system is provided. The system may include at least one storage medium including a set of instructions, and at least one processor in communication with the at least one storage medium. When executing the instructions, the at least one processor may be configured to direct the system to perform operations including receiving a first payment request initiated by a first user. The first payment request may be related to a service provided to a second user. The operations may further include collecting first information related to the service provided to the second user and generating a first verification result by verifying the first information according to a first preset rule. The operations may further include generating a second verification result by verifying whether the first user is authorized to initiate the first payment request according to a second preset rule, and determining whether the first payment request is approved at least based on the first verification result and the second verification result.

In some embodiments, to generate the second verification result by verifying whether the first user is authorized to initiate the first payment request according to a second preset rule, the at least one processor may be configured to direct the system to perform additional operations including receiving a second payment request initiated by the second user. The second payment request may be related to the service provided to the second user. The additional operations may further include collecting second information related to the second service, and determining a time difference between a first time point associated with the first payment request and a second time point associated with the second payment request. The additional operations may further include determining whether the time difference is less than or equal to a preset time. The additional operations may further include, in response to a determination that the time difference is less than the preset time, verifying that the first user is unauthorized to initiate the first payment request.

In some embodiments, the at least one processor may be configured to direct the system to perform additional operations including deleting information of the first payment request.

In some embodiments, the at least one processor may be configured to direct the system to perform additional operations including generating a third verification result by verifying the second information according to a third preset rule, and determining whether the second payment request is approved at least based on the third verification result.

In some embodiments, to generate the third verification result by verifying the second information according to the third preset rule, the at least one processor may be configured to direct the system to perform additional operations including determining one or more second parameters based on the second information and determining one or more second matching degrees associated with the one or more second parameters. The additional operations may further include comparing the one or more second matching degrees with one or more second matching degree thresholds. The additional operations may further include, in response to a result of the comparison that the one or more second matching degrees may be greater than the one or more second matching degree thresholds, generating the third verification result that the second information may be verified to be eligible.

In some embodiments, to generate the first verification result by verifying the first information according to the first preset rule, the at least one processor may be configured to direct the system to perform additional operations including determining one or more first parameters based on the first information and determining one or more first matching degrees associated with the one or more first parameters. The additional operations may further include comparing the one or more first matching degrees with one or more first matching degree thresholds. The additional operations may further include, in response to a result of the comparison that the one or more first matching degrees is greater than the one or more first matching degree thresholds, generating the first verification result that the first information is verified to be eligible.

In some embodiments, at least one of the one or more first parameters or the one or more second parameters may include at least one of a location related to the service provided to the second user, a time when the service is provided to the second user, a time duration related to the service provided to the second user, or a category of the service provided to the second user.

In some embodiments, the at least one processor may be configured to direct the system to perform additional operations including determining first geographical information of a service provider that provides the service to the second user and determining second geographical information of a location where the service may be provided to the second user. The additional operations may further include determining, based on the first geographical information and the second geographical information, at least one of the one or more first matching degrees or the one or more second matching degrees.

In some embodiments, the first geographical information may include a first character string, and the second geographical information may include a second character string. To determine, based on the first geographical information and the second geographical information, the at least one of the one or more first matching degrees or the one or more second matching degrees, the at least one processor may be configured to direct the system to perform additional operations. The additional operations may include determining, based on the first character string and the second character string, the at least one of the one or more first matching degrees or the one or more second matching degrees.

In some embodiments, to determine, based on the first geographical information and the second geographical information, the at least one of the one or more first matching degrees or the one or more second matching degrees, the at least one processor may be configured to direct the system to perform additional operations. The additional operations may include determining a first region based on the first geographical information and determining a second region based on the second geographical information. The additional operations may further include determining, based on the first region and the second region, the at least one of the one or more first matching degrees or the one or more second matching degrees.

In some embodiments, the at least one processor may be configured to direct the system to perform additional operations including determining a time duration related to the service provided to the second user. The additional operations may further include determining, based on the time duration and a preset time duration, the at least one of the one or more first matching degrees or the one or more second matching degrees.

According to yet another aspect of the present disclosure, a method is provided. The method may be implemented on a computing device. The computing device may have at least one processor and at least one non-transitory storage medium. The method may include receiving a first payment request initiated by a first user. The first payment request may be related to a service provided to a second user. The method may further include collecting first information related to the service provided to the second user and generating a first verification result by verifying the first information according to a first preset rule. The method may further include generating a second verification result by verifying whether the first user is authorized to initiate the first payment request according to a second preset rule, and determining whether the first payment request is approved at least based on the first verification result and the second verification result.

According to still another aspect of the present disclosure, a system is provided. The system may further include an obtaining module. The obtaining module may be configured to receive a first payment request initiated by a first user. The first payment request may be related to a service provided to a second user. The obtaining module may be further configured to collect first information related to the service provided to the second user. The system may further include a determination module. The determination module may be configured to generate a first verification result by verifying the first information according to a first preset rule, and generate a second verification result by verifying whether the first user may be authorized to initiate the first payment request according to a second preset rule. The determination module may be further configured to determine whether the first payment request is approved at least based on the first verification result and the second verification result.

According to still another aspect of the present disclosure, a non-transitory computer readable medium is provided. The non-transitory computer readable medium may include at least one set of instructions. When executed by at least one processor, the at least one set of instructions may direct the at least one processor to effectuate a method. The method may include receiving a first payment request initiated by a first user. The first payment request may be related to a service provided to a second user. The method may further include collecting first information related to the service provided to the second user and generating a first verification result by verifying the first information according to a first preset rule. The method may further include generating a second verification result by verifying whether the first user is authorized to initiate the first payment request according to a second preset rule, and determining whether the first payment request is approved at least based on the first verification result and the second verification result.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary payment management system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating an exemplary terminal device according to some embodiments of the present disclosure;

FIG. 4 is a block diagram illustrating an exemplary processing engine according to some embodiments of the present disclosure;

FIG. 5 is a flowchart illustrating an exemplary process for payment management according to some embodiments of the present disclosure;

FIG. 6 is a flowchart illustrating a payment management method according to some exemplary embodiments of the present disclosure;

FIG. 7 is a flowchart illustrating a payment management method according to some exemplary embodiments of the present disclosure;

FIG. 8 is a flowchart illustrating a payment management method according to some exemplary embodiments of the present disclosure;

FIG. 9 is a flowchart illustrating a payment management method according to some exemplary embodiments of the present disclosure;

FIG. 10 is a schematic block diagram illustrating a payment management system according to some exemplary embodiments of the present disclosure;

FIG. 11 is a schematic diagram illustrating a payment management system according to some exemplary embodiments of the present disclosure;

FIG. 12 is a flowchart illustrating an exemplary process for payment management according to some exemplary embodiments of the present disclosure;

FIG. 13 is a flowchart illustrating a fee payment management process according to some exemplary embodiments of the present disclosure;

FIG. 14 is a flowchart illustrating a fee payment management process according to some exemplary embodiments of the present disclosure;

FIG. 15 is a flowchart illustrating a fee payment management process according to some exemplary embodiments of the present disclosure;

FIG. 16 is a schematic diagram illustrating a fee payment management system according to some exemplary embodiments of the present disclosure;

FIG. 17 is a schematic diagram illustrating a fee payment management system according to some exemplary embodiments of the present disclosure;

FIG. 18 is a schematic diagram illustrating a fee payment management system according to some exemplary embodiments of the present disclosure;

FIG. 19 is a schematic diagram illustrating a computing device according to some exemplary embodiments of the present disclosure;

FIG. 20 is a schematic diagram illustrating a terminal interface of pre-adding a first user in the fee payment management according to some exemplary embodiments of the present disclosure;

FIG. 21 is a schematic diagram illustrating a terminal interface of pre-adding a second user in the fee payment management according to some exemplary embodiments;

FIG. 22 is a schematic diagram illustrating an exemplary interface of a terminal application (APP) related to the fee payment management according to some exemplary embodiments of the present disclosure;

FIG. 23 is a schematic diagram illustrating an exemplary interface of a terminal APP related to the fee payment management method according to some exemplary embodiments of the present disclosure;

FIG. 24 is a schematic diagram illustrating an exemplary interface of a terminal APP related to the fee payment management according to some exemplary embodiments of the present disclosure;

FIG. 25 is a schematic diagram illustrating an exemplary interface of a terminal APP related to the fee payment management according to some exemplary embodiments of the present disclosure;

FIG. 26 is a schematic diagram illustrating an exemplary interface of a terminal APP related to the fee payment management according to some exemplary embodiments of the present disclosure;

FIG. 27 is a schematic diagram illustrating an exemplary computer interface related to the fee payment management according to some exemplary embodiments of the present disclosure; and

FIG. 28 is a schematic diagram illustrating an exemplary computer interface related to the fee payment management according to some exemplary embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

An aspect of the present disclosure relates to systems, methods, and/or computer readable mediums for payment management. Specifically, a payment request initiated by a user may be received from a requester terminal associated with the user. The payment request may include information related to a service provided to the user, such as an accommodation service, a transportation service, etc. The eligibility of the payment request may be determined based on the information related to the service. For instance, the information related to the service may include first geographical information of the service provider and second geographical information of a location where the service is provided to the user. The first geographical information and the second geographical information may be compared. In response to a determination that the first geographical information is correlated to the second geographical information, the payment request may be determined as eligible. A payment amount of money may be transacted to a financial account (e.g., a bank account) of the user.

In some cases, the user may designate a proxy to represent the user and initiate the payment request. The proxy may be referred to as a first user and the user to whom the service is provided may be referred to as a second user. A determination may be conducted on whether the first information is eligible and whether the first user is eligible for representing the second user. In response to a determination that the first information is verified to be eligible and that the first user is eligible for representing the second user, the payment request may be approved. The payment amount corresponding to the payment initiated by the first user may be transacted to a financial account of the second user. In some cases, the first user may be a service provider who provides the service to the second user. The payment request may be intended to pay for the service. In response to a determination that the first information is verified to be eligible, and that the first user is eligible for representing the second user, the payment request may be approved. In some cases, two payment requests respectively initiated by the first user and the second user may be received. A time difference between a time point of receiving the payment request initiated by the first user (referred to as a first payment request) and a time point of receiving the payment request initiated by the second user (referred to as a second payment request) may be determined. In response to a determination that the time difference is less than or equal to a preset time length, the first payment request may be determined as ineligible. A determination may be conducted on whether the second payment request is eligible to be approved. In response to a determination that the second payment request is eligible to be approved, a payment amount of money corresponding to the second payment request may be transacted to the financial account of the second user or the first user.

Moreover, in some embodiments of the present disclosure, the systems and methods may employ at least one of techniques including embedding authentication information in the payment request and/or in the information to a requester terminal, encrypting data for transmission, decrypting received data if the embedded authentication information is verified, or the like, or a combination thereof. This may allow secured communication and/or accurate transmission of specific data from/to specific requester terminals.

As used herein, the term “payment request” may refer to a request for getting paid by an amount of money, or a request for paying an amount of money. In some embodiments, the payment request may be associated with a service provided to a user for a business reason. The user may have paid a fee for the service, and may initiate a payment request to get paid back (i.e., as a reimbursement) by a person or an organization (e.g., a company that hires the user). In some embodiments, a user (i.e., the first user) may initiate the payment request on behalf of the user to whom the service is provided (i.e., the second user). If the payment request is approved, an amount of money may be paid to the second user. In some embodiments, the payment request may be associated with a payment for a service provided to a user (i.e., a service requester). The service requester or a service provider may initiate the payment request. For instance, if the payment request initiated by the service requester or the service provider is approved, an amount of money may be paid to the service provider.

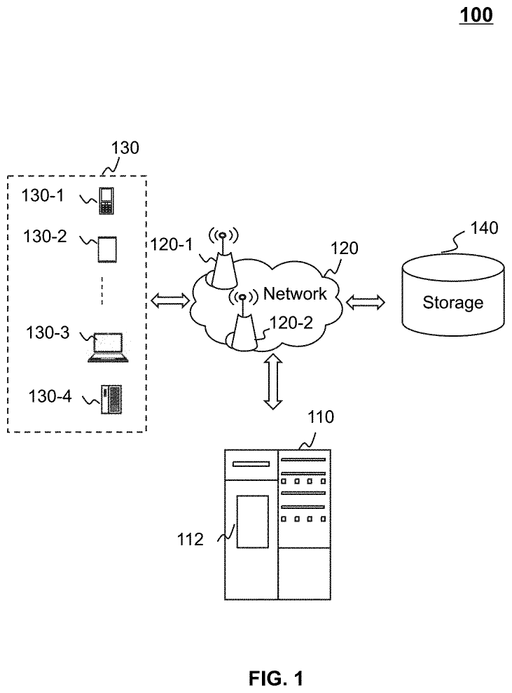

FIG. 1 is a schematic diagram illustrating an exemplary payment management system according to some embodiments of the present disclosure. For example, the payment management system 100 may be a system for managing payment requests and payment corresponding to the payment requests. The payment management system 100 may include a server 110, a network 120, a user terminal 130, and a storage device 140.

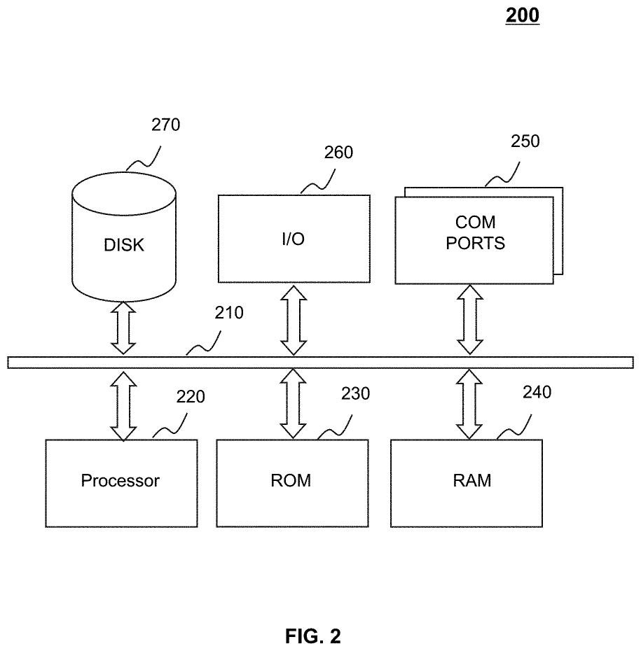

The server 110 may be configured to process data related to a payment request. In some embodiments, the server 110 may receive a payment request from a user via a requester terminal (e.g., the user terminal 130). The payment request may include information related to a service provided to the user. The server 110 may determine whether the reimbursement is eligible based on information related to the service provided to the user. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the user terminal 130, and/or the storage device 140 via the network 120. As another example, the server 110 may be directly connected to the user terminal 130, and/or the storage device 140 to access information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process data associated with a payment request to perform one or more functions of the server 110 described in the present disclosure. In some embodiments, the processing engine 112 may receive the payment request initiated by the user from a requester terminal associated with the user. The processing engine 112 may further determine whether the payment request is eligible based on the information related to the service provided to the user. For instance, the processing engine 112 may compare first geographical information and second geographical information associated with the payment request. In response to a determination that the first geographical information and the second geographical information is correlated, the processing engine 112 may determine that the payment request is eligible. In some embodiments, the payment request may be initiated by another user (referred to as a first user) on behalf of the user provided with the service (referred to as a second user). The processing engine 112 may further determine whether the first user is eligible for representing the second user. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof. In some embodiments, the processing engine 112 may be capable of decrypting an encrypted payment request from a requester terminal.

The network 120 may facilitate exchange of information and/or data. In some embodiments, one or more components in the payment management system 100 (e.g., the server 110, the user terminal 130, and/or the storage device 140) may transmit information and/or data to other component(s) in the payment management system 100 via the network 120. For example, the server 110 may obtain/acquire a payment request from the user terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the network 120 may include one or more network access points. For example, the network 120 may include wired or wireless network access points such as base stations and/or internet exchange points 120-1, 120-2, . . . , through which one or more components of the payment management system 100 may be connected to the network 120 to exchange data and/or information.

The user terminal 130 may be associated with a user. In some embodiments, the user may initiate a payment request via the user terminal 130. The user terminal 130 may transmit the payment request to the server 110 (e.g., the processing engine 112). In some embodiments, the user may view the submitted payment request, modify or withdraw the submitted payment request. In some embodiments, the user terminal 130 may be configured with a positioning transceiver component. The user terminal 130 may determine the second geographical information that indicates a position where the service is provided to the user via the positioning transceiver component.

In some embodiments, the payment request may be encrypted by the user terminal 130, the processing engine 112 may decrypt the encrypted payment request after receiving the encrypted payment request. Merely by way of example, the user terminal 130 may encrypt the payment request using its private key and/or by digitally signing the payment request. The processing engine 112 may decrypt the payment request using a public key of the user terminal 130. In some embodiments, the encrypted payment request may include authentication information related to the user terminal 130 and/or the requester, such as an identification of the requester, a password inputted by the requester, and/or a digital signature of the user terminal 130. The processing engine 112 may verify the authentication information of the user terminal 130 and/or the requester before the decrypting. In some embodiments, the user terminal 130 may include a mobile device 130-1, a tablet computer 130-2, a laptop computer 130-3, a tabletop computer 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, the user terminal 130 may be a wireless device with positioning technology for locating the position of the user and/or the user terminal 130.

The storage device 140 may store data and/or instructions. In some embodiments, the storage device 140 may store data obtained/acquired from the user terminal 130. For example, the storage device 140 may store the payment request received from the user terminal 130. In some embodiments, the storage device 140 may store data and/or instructions that the server 110 may execute or use to perform exemplary methods described in the present disclosure. In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components in the payment management system 100 (e.g., the server 110, the user terminal 130, etc.). One or more components in the payment management system 100 may access the data or instructions stored in the storage device 140 via the network 120. In some embodiments, the storage device 140 may be directly connected to or communicate with one or more components in the payment management system 100 (e.g., the server 110, the user terminal 130, etc.). In some embodiments, the storage device 140 may be part of the server 110.

In some embodiments, one or more components in the payment management system 100 (e.g., the server 110, the user terminal 130, etc.) may have a permission to access the storage device 140. In some embodiments, one or more components in the payment management system 100 may read and/or modify information related to a user when one or more conditions are met. For example, the server 110 may obtain target data from the storage device 140, including sample keywords, popularity information, preference information associated with the user of the user terminal 130, statistical data related to at least one travel means (also referred to as travel means information), or the like, or a combination thereof.

One of ordinary skills in the art would understand that when an element of the payment management system 100 performs an operation, the element may perform through electrical signals and/or electromagnetic signals. For example, after the user submits a payment request via the terminal 130, the terminal device 130 may transmit electrical signals encoding the payment request to the processing engine 112. When the processing engine 112 processes a task, such as determining whether the reimbursement is eligible, the processing engine 112 may operate logic circuits to perform such task.

FIG. 2 is a schematic diagram illustrating exemplary hardware and/or software components of a computing device according to some embodiments of the present disclosure. In some embodiments, the server 110 and/or the user terminal 130 may be implemented on the computing device 200 shown in FIG. 2. For example, the processing engine 112 may be implemented on the computing device 200 and configured to perform functions of the processing engine 112 disclosed in this disclosure.

The computing device 200 may be used to implement any component of the payment management system 100 as described herein. For example, the processing engine 112 may be implemented on the computing device 200, via its hardware, software program, firmware, or a combination thereof. Although only one such computer is shown, for convenience, the computer functions relating to payment management as described herein may be implemented in a distributed fashion on a number of similar platforms to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may further include program storage and data storage of different forms including, for example, a disk 270, and a read-only memory (ROM) 230, or a random-access memory (RAM) 240, for various data files to be processed and/or transmitted by the computing device. The exemplary computing device may also include program instructions stored in the ROM 230, RAM 240, and/or another type of non-transitory storage medium to be executed by the processor 220. The methods and/or processes of the present disclosure may be implemented as the program instructions. The computing device 200 may also include an I/O component 260, supporting input/output between the computer and other components. The computing device 200 may also receive programming and data via network communications.

Merely for illustration, only one processor is illustrated in FIG. 2. Multiple processors 220 are also contemplated; thus, operations and/or method steps performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors 220 jointly or separately in the computing device 200 (e.g., a first processor executes step A and a second processor executes step B, or the first and second processors jointly execute steps A and B).

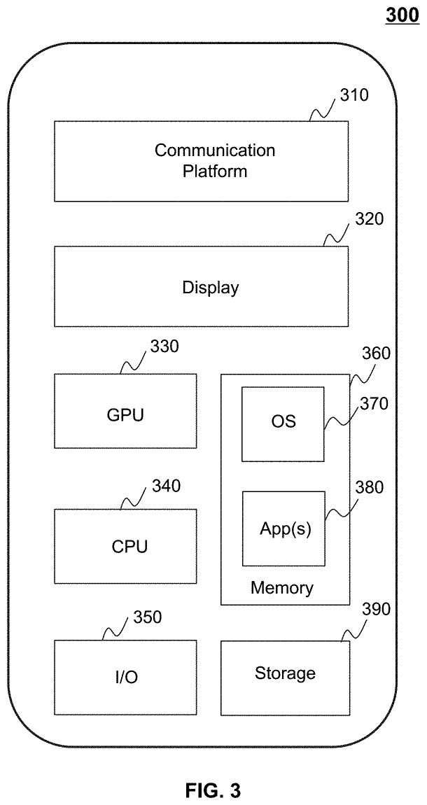

FIG. 3 is a schematic diagram illustrating exemplary hardware and/or software components of a terminal device according to some embodiments of the present disclosure. In some embodiments, the user terminal 130 may be implemented on the terminal device 300 shown in FIG. 3. The terminal device 300 may be a mobile device, such as a mobile phone, a smart watch, etc. As illustrated in FIG. 3, the terminal device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the terminal device 300.

In some embodiments, an operating system 370 (e.g., iOS™, Android™, Windows Phone™, etc.) and one or more Apps (applications) 380 may be loaded into the memory 360 from the storage 390 in order to be executed by the CPU 340. In some embodiments, the terminal device 300 may include a positioning transceiver component. The terminal device 300 may determine the second geographical information that indicates a position where the service is provided to the user via the positioning transceiver component. In some embodiments, the user may initiate a payment request via the terminal device 300. The user may also view, modify, or withdraw the payment request via the terminal device 300. User interactions may be achieved via the I/O 350 and provided to the server 110 and/or other components of the payment management system 100 via the network 120.

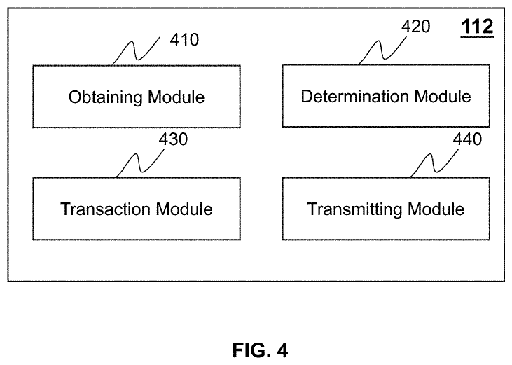

FIG. 4 is a block diagram illustrating an exemplary processing engine according to some embodiments of the present disclosure. The processing engine 112 may be in communication with a storage medium (e.g., the storage device 140 of the payment management system 100, and/or the storage 390 of the terminal device 300), and may execute instructions stored in the storage medium. In some embodiments, the processing engine 112 may include an obtaining module 410, a determination module 420, a transaction module 430, and a transmission module 440. In some embodiments, the processing engine 112 may be integrated into the server 110.

The obtaining module 410 may obtain data related to payment management. In some embodiments, the obtaining module 410 may receive a payment request including information related to a service provided to a user by a service provider. The information related to the service may include first geographical information of the service provider. Specifically, the obtaining module 410 may receive the payment request from a requester terminal (e.g., the user terminal 130 shown in FIG. 1) associated with the user. For instance, the user may be an employee of a company, a government department, a non-profit organization, or the like. The payment request may be associated with a reimbursement. As another example, the user may be a service requester. In some embodiments, the user may initiate the payment request to pay for a service provided to the user (i.e., a service requester). The user may initiate the payment request by providing information related to the service. In some embodiments, the obtaining module 410 may further obtain second geographical information of a location where the service is provided to the user.

In some embodiments, the obtaining module 410 may receive a first payment request initiated by a first user and first information related to a service provided to a second user. In some embodiments, the first payment request may be associated with a service provided to the second user for a business reason. The second user may have paid a fee for the service. The first user may initiate a payment request to allow the second user to get paid back (i.e., as a reimbursement) by a person or an organization (e.g., a company that hires the user). In some embodiments, the first user may initiate the first payment request on behalf of the second user (i.e., as a proxy of the second user) via a first requester terminal (e.g., the user terminal 130). If the payment request is determined to be approved (i.e., eligible), a certain amount of money corresponding to the service may be paid to the second user. In some embodiments, the payment request may be associated with a payment for a service provided by the first user to the second user (i.e., a service requester). The service requester or a service provider may initiate the payment request. For instance, if the payment request initiated by the service requester or the service provider is approved, an amount of money may be paid to the service provider. Additionally or alternatively, the obtaining module 410 may receive a second payment request initiated by the second user and second information related to the service provided to the second user.

The determination module 420 may determine data related to payment management. In some embodiments, the determination module 420 may determine whether the payment request is approved (i.e., eligible to be approved) according to a preset rule at least based on the result of a comparison between the first geographical information and the second geographical information. In some embodiments, the first geographical information may include a first character string (e.g., characters or words for describing the location of the entity of the service provider), and the second geographical information may include a second character string (characters or words for describing the location where the service is provided to the user). The determination module 420 may determine a similarity between the first character string and the second character string. In response to a determination that the similarity between the first character string and the second character string exceeds a similarity threshold (e.g., 0.4, 0.5), the determination module 420 may determine that the payment request is eligible (i.e., the payment request is successfully verified).

In some embodiments, the determination module 420 may determine a first region based on the first geographical information and determine a second region based on the second geographical information. The determination module 420 may further determine an overlap between the first region and the second region. The preset rule may include that in response to a determination that the overlap between the first region and the second region exceeds an overlap threshold, the determination module 420 may determine that the location of the service provider (interchangeably referred to as a first geographical location) is correlated to the location where the service is provided to the user (interchangeably referred to as a second geographical location), and that the reimbursement is eligible. In some embodiments, the overlap threshold may be denoted as a proportion of the first region or the second region (e.g., 0.4, 0.5).

In some embodiments, the determination module 420 may determine a time duration (i.e., dwell time) related to the service. The preset rule may include that in response to a determination that the time duration related to the service exceeds a time threshold, the determination module 420 may determine that the payment request is eligible.

In some embodiments, the determination module 420 may generate a first verification result by verifying the first information according to a first preset rule. The determination module 420 may generate a second verification result by verifying whether the first user is authorized to initiate the first payment request according to a second preset rule. The determination module 420 may further determine whether the first payment request initiated by the first user is eligible to be approved at least based on the first verification result and the second verification result. In some embodiments, the determination module 420 may determine a time difference between a first time point associated with the first payment request and a second time point associated with the second reimbursement. In response to a determination that the time difference is less than the preset time, the processing engine 112 may verify that the first user is not eligible for initiating the first payment request. In some embodiments, the determination module 420 may further generate a third verification result by verifying the second information according to a third preset rule. The determination module 420 may determine whether the second payment request is eligible to be approved at least based on the third verification result.

The transaction module 430 may transact an amount of money to a financial account. In some embodiments, the payment request may be associated with a reimbursement. The transaction module 430 may transact the payment amount of money to the financial account of the second user. In some embodiments, the payment request may be associated with a payment for the service provided to the second user. The transaction module 430 may transact the payment amount of money to the financial account of the first user (e.g., a service provider).

The modules in FIG. 4 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. In some embodiments, two or more of the modules may be combined into a single module, and any one of the modules may be divided into two or more units. In some embodiments, one or more of the modules in FIG. 4 may be omitted. For instance, the transaction module 430 mat be omitted.

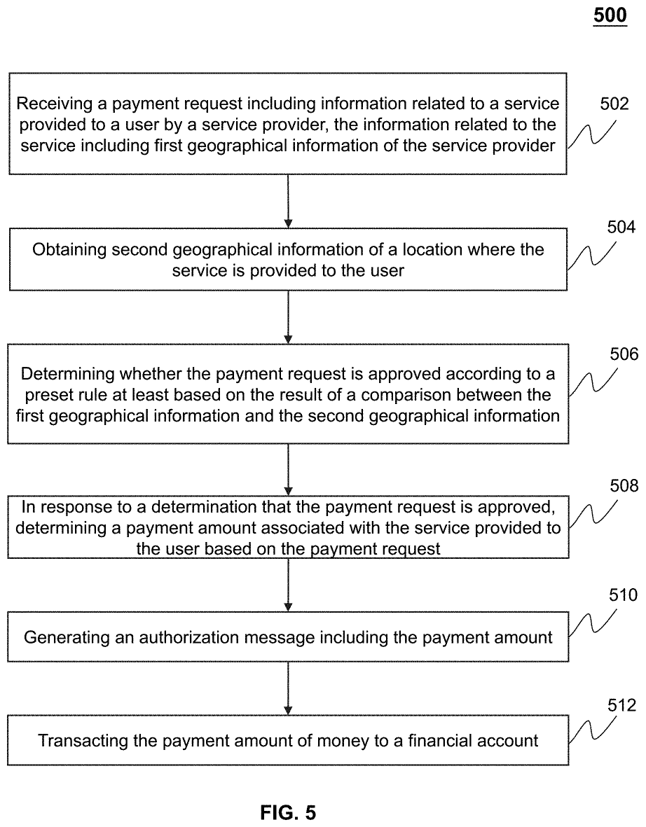

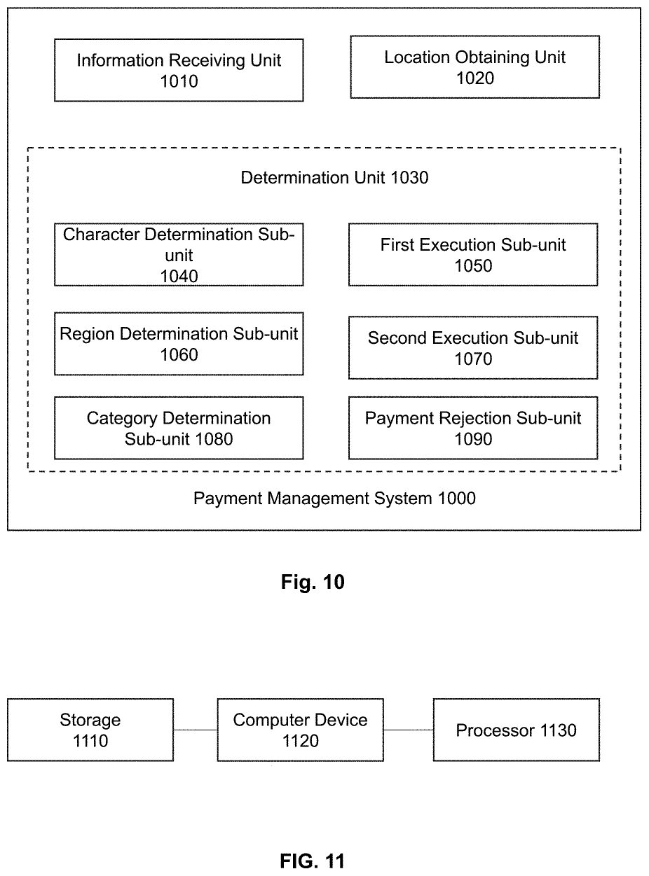

FIG. 5 is a flowchart illustrating an exemplary process for payment management according to some embodiments of the present disclosure. The process 500 may be executed by the payment management system 100. For example, the process 500 may be implemented as a set of instructions (e.g., an application) stored in the storage (e.g., ROM 230 or RAM 240 of the computing device 200). The processing engine 112, the modules in FIG. 4 and/or units in FIG. 10 may execute the set of instructions, and when executing the instructions, the processing engine 112 and/or the modules may be configured to perform the process 500. The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 502, the processing engine 112 (e.g., the obtaining module 410) may receive a payment request including information related to a service provided to a user by a service provider. The information related to the service may include first geographical information of the service provider. Specifically, the processing engine 112 may receive the payment request from a requester terminal (e.g., the user terminal 130 shown in FIG. 1) associated with the user. For instance, the user may be an employee of a company, a government department, a non-profit organization, or the like. The payment request may be associated with a reimbursement. As another example, the user may be a service requester. In some embodiments, the user may initiate the payment request to pay for a service provided to the user (i.e., a service requester). The user may initiate the payment request by providing information related to the service. As used herein, the payment request is interchangeably referred to as a payment request or a fee payment request. If the payment request is determined to be eligible, the employer of the user may pay a payment amount of money corresponding to the service to the user. For instance, the service may include but not limited to an accommodation service, a food and drink service, a transportation service, or the like, or any combination thereof.

In some embodiments, the information related to the service may include the time when the service is provided to the service provider, the location where the service is provided to the service provider, the fee paid for the service, the duration of the service, a payment amount, or the like, or any combination thereof. The user may fill in the information related to the service in a reimbursement form via the requester terminal. In some embodiments, the information related to the service may include first geographical information of the service provider that provides the service to the user. Specifically, the first geographical information may include a geographical location of an entity of the service provider (e.g., a restaurant or a hotel). In some embodiments, the information related to the service may include a consumption evidence (e.g., a photo of an invoice, an electronic invoice) corresponding to the service, which may include an address of the service provider. The first geographical information may be determined based on the address of the service provider.

In some embodiments, the requester terminal may encrypt the payment request, and transmit the encrypted payment request to the processing engine 112. For example, the requester terminal may encrypt the payment request using its private key and/or by digitally signing the payment request. In some embodiments, the encrypted payment request may include authentication information related to the requester terminal and/or the requester (i.e., the user of the requester terminal), such as an identification of the requester, a password inputted by the requester, a digital signature of the requester terminal. The authentication information may allow the processing engine 112 to verify the requester terminal and/or the requester.

In 504, the processing engine 112 (e.g., the obtaining module 410) may obtain second geographical information of a location where the service is provided to the user. In some embodiments, the second geographical information may be generated by a positioning transceiver component of a terminal device (e.g., a mobile phone or a smart watch) using a positioning technique. For instance, the positioning technique may be implemented via a global positioning system (GPS), a global navigation satellite system (GLONASS), a Galileo positioning system, a quasi-zenith satellite system (QZSS), a Beidou navigation satellite system, a wireless fidelity (WiFi) positioning technology, or the like, or any combination thereof. In some embodiments, the second geographical information may include a prescribed geographical location. The prescribed geographical location may be predetermined by the employer of the user. For instance, the prescribed geographical location may be the location of a hotel booked for the user, or a destination of a business trip of the user.

In 506, the processing engine 112 (e.g., the determination module 420) may determine whether the payment request is approved (i.e., eligible to be approved) according to a preset rule at least based on the result of a comparison between the first geographical information and the second geographical information. In some embodiments, the first geographical information may include a first character string (e.g., characters or words for describing the location of the entity of the service provider), and the second geographical information may include a second character string (characters or words for describing the location where the service is provided to the user). The processing engine 112 may determine a similarity between the first character string and the second character string. In response to a determination that the similarity between the first character string and the second character string exceeds a similarity threshold (e.g., 0.4, 0.5), the processing engine 112 may determine that the payment request is eligible (i.e., the payment request is successfully verified). In some embodiments, the preset rule may include that in response to a determination that the similarity between the first character string and the second character string is less than or equal to the similarity threshold, the processing engine 112 may determine that the payment request is ineligible (i.e., the payment request may not be approved).

In some embodiments, the processing engine 112 may determine a first region based on the first geographical information and determine a second region based on the second geographical information. The processing engine 112 may further determine an overlap between the first region and the second region. The preset rule may include that in response to a determination that the overlap between the first region and the second region exceeds an overlap threshold, the processing engine 112 may determine that the location of the service provider (interchangeably referred to as a first geographical location) is correlated to the location where the service is provided to the user (interchangeably referred to as a second geographical location), and that the reimbursement is eligible. In some embodiments, the overlap threshold may be denoted as a proportion of the first region or the second region (e.g., 0.4, 0.5).

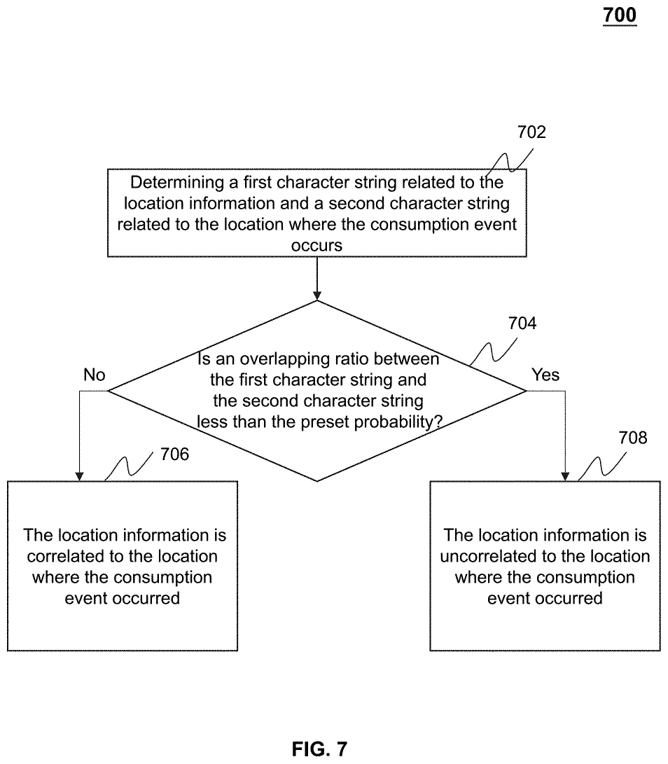

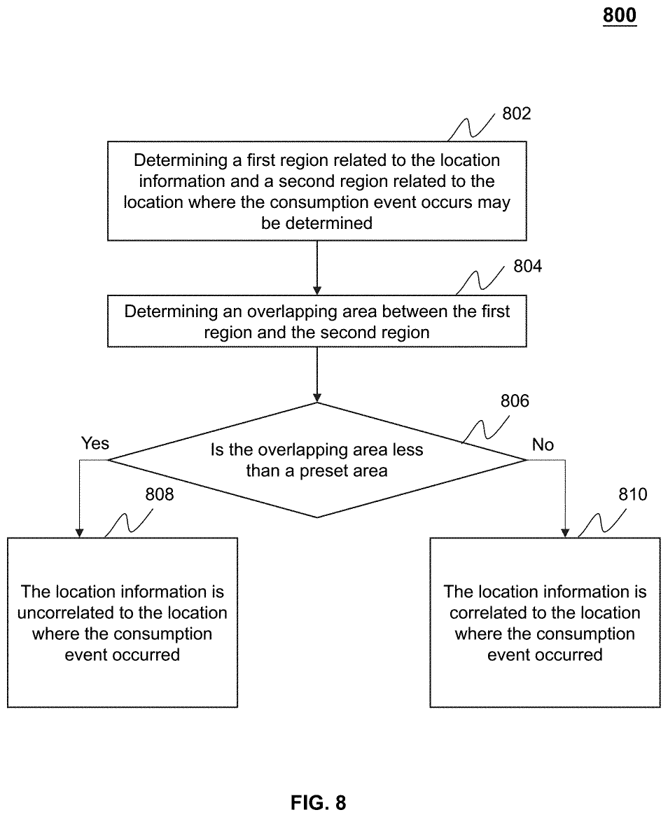

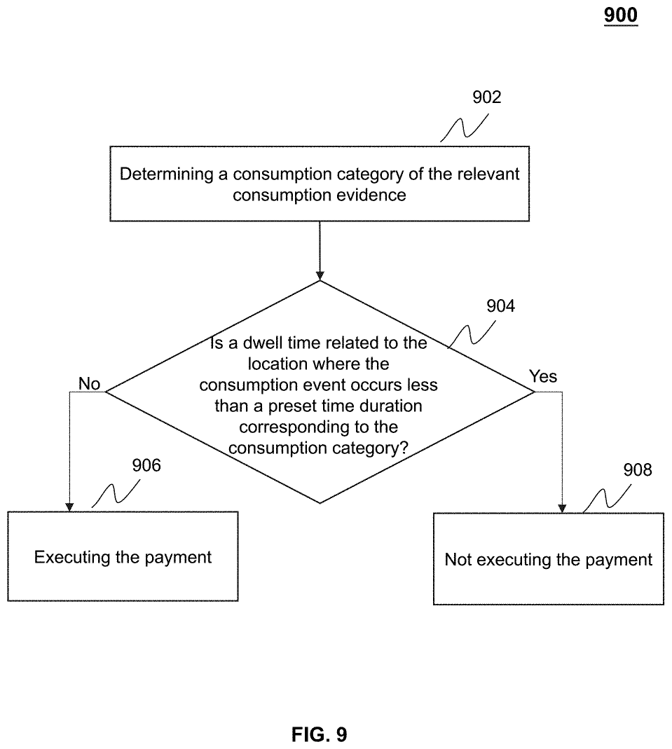

In some embodiments, the processing engine 112 may determine a time duration (i.e., dwell time) related to the service. The preset rule may include that in response to a determination that the time duration related to the service exceeds a time threshold, the processing engine 112 may determine that the payment request is eligible. More descriptions regarding the determination of whether the reimbursement is eligible may be found elsewhere in the present disclosure, for example, in FIG. 7, FIG. 8, FIG. 9 and/or the description thereof.

In 508, in response to a determination that the payment request is approved, the processing engine 112 (e.g., the determination module 420) may determine a payment amount associated with the service provided to the user based on the payment request. Specifically, the payment amount may be determined based on the invoice (e.g., an electronic invoice) included in the payment request.

In 510, the processing engine 112 (e.g., the determination module 420) may generate an authorization message including the payment amount. The authorization message may be transmitted to a terminal device associated with the financial personnel of the organization (e.g., a company) that hires the user. The authorization message may be configured to authorize the financial personnel to transact the payment amount of money to the user. In some embodiments, the processing engine 122 may generate a notification message to notify the user that the payment request has been approved, and that a certain amount of money will be transacted to the financial account of the user.

In 512, the processing engine 112 (e.g., the transaction module 430) may transact the payment amount of money to a financial account. In some embodiments, the payment request may be associated with a reimbursement. The payment amount of money may be transacted to the financial account of the user to whom the service is provided. In some embodiments, the payment request may be associated with a payment for the service provided to the user. The payment amount of money may be transacted to the financial account of the service provider. The financial account may include, for example, a bank account, or a third-party electronic account such as an account of the WeChat wallet, Alipay, PayPal, or the like. In some embodiments, the payment amount of money may be transacted to the financial account of the user by the financial personnel.

It should be noted that the above description of FIG. 5 is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure. In some embodiments, operation 502 and operation 504 may be performed simultaneously or sequentially in any order.

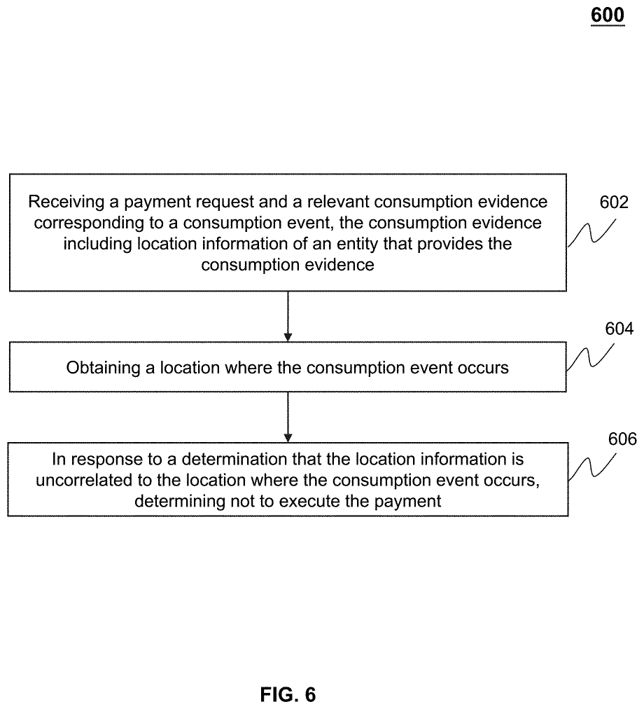

FIG. 6 is a flowchart illustrating a payment management process according to some exemplary embodiments of the present disclosure. The process 600 may be executed by the payment management system 100 shown in FIG. 1 or the payment management system 1000 shown in FIG. 10. For example, the process 600 may be implemented as a set of instructions (e.g., an application) stored in the storage (e.g., ROM 230 or RAM 240 of the computing device 200). The processing engine 112, the modules in FIG. 4 and/or units in FIG. 10 may execute the set of instructions, and when executing the instructions, the processing engine 112 and/or the modules may be configured to perform the process 600. The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting. As shown in FIG. 6, the payment management process of an embodiment according to the present disclosure may include the following operations.

In 602, a payment request and a relevant consumption evidence corresponding to a consumption event may be received. The consumption evidence may include location information of an entity that provides the consumption evidence.

In 604, a location where the consumption event occurs may be obtained.

In 606, in response to a determination that the location information is uncorrelated to the location where the consumption event occurs, the processing engine 112 may determine not to execute the payment.

During daily work, a large number of consumption events occur every day, and the reimbursement payment requirements are generated consequently. In some embodiments, the consumption evidence may include a receipt, an invoice, a transaction record, or the like, or any combination thereof. The payment request may be initiated by a user (e.g., an employee) for reimbursement. In some embodiments, the payment request is interchangeably referred to as reimbursement payment request. In some embodiments, after the payment request and the consumption evidence are received, the payment request and the consumption evidence are generally checked manually. In this way, a large amount of screening and verification work is required, which may easily lead to mistakes and omissions.

For example, a payment request from a user may be associated with accommodation expenses at a certain place. The user may provide five invoices. Financial personnel may need to check and perform statistics on each of the five invoices for information such as whether the invoice is an accommodation invoice, an amount related to the invoice, an accommodation date, or the like, or any combination thereof. This process may be inefficient and tricky, and the financial personnel can only determine the place where the consumption occurs according to a request from the user through checking the invoice.

In some embodiments, the invoice provided by the reimbursement payment request may have the address of the invoicing provider, that is, the location information in which an entity of the service provider that provides the invoice (interchangeably referred to as first geographical information). For instance, the processing engine 112 may use an optical character recognition (OCR) technique to recognize the first geographical information based on a photo of an invoice, an electronic invoice, etc. A comparison between an actual location where the consumption event occurs and a location of the entity that provides the evidence may be carried out based on the location information of the entity that provides the evidence, so that the validity of the consumption event may be determined. Merely by way of example, if a user travels to place A on a business trip, A is the location where the consumption event occurs. But if the accommodation invoice is issued by a hotel in place B, obviously, the two places do not match. The consumption event may be an invalid consumption event, and the reimbursement payment may not be executed (e.g., by the processing engine 112, or by the finance staff).

Through the process 600, an evidence is provided for whether the consumption event is valid or whether the consumption evidence is authentic, which may reduce the possibility of misidentification, the error rate of payment work, the possibility of invalid consumption event being paid, and the labor intensity. Thus the overall work efficiency of the company may be improved.

There may be various ways to obtain the location related to the consumption event. For example, the location where the consumption event occurs may be determined based on an address of a task to be executed, which may be included in the task scheduled by the company. The task scheduled by the company may be stored in a storage device that is accessible to the processing engine 112. For another example, the location related to the consumption event may be obtained by a positioning technique using the mobile terminal held by the user. Specifically, information related to the location of the consumption event the second geographical information may be obtained by a positioning transceiver component of a terminal device associated with the user (e.g., using a GPS positioning technique). Details regarding determining whether the location information is correlated to the location where the consumption event occurs may also be found elsewhere in the present disclosure, for example, in FIG. 7 and FIG. 8.

FIG. 7 is a flowchart illustrating a payment management process according to some exemplary embodiments of the present disclosure. The process 700 may be executed by the payment management system 100 shown in FIG. 1 or the payment management system 1000 shown in FIG. 10. For example, the process 700 may be implemented as a set of instructions (e.g., an application) stored in the storage (e.g., ROM 230 or RAM 240 of the computing device 200). The processing engine 112, the modules in FIG. 4 and/or units in FIG. 10 may execute the set of instructions, and when executing the instructions, the processing engine 112 and/or the modules may be configured to perform the process 700. The operations of the illustrated process 700 presented below are intended to be illustrative. In some embodiments, the process 700 may be accomplished with one or more additional operations not described, and/or without one or more of the operations discussed. Additionally, the order in which the operations of the process 700 as illustrated in FIG. 7 and described below is not intended to be limiting. As shown in FIG. 7, determining whether the location information is correlated to the location where the consumption event occurs may include the following operations.

In 702, a first character string related to the location information (i.e., the first geographical information) and a second character string related to the location where the consumption event occurs may be determined.

In 704, an overlapping ratio (interchangeably referred to as a similarity) between the first character string and the second character string may be compared with a preset probability to determine whether the overlapping ratio is less than the preset probability.

In 706, if the overlapping ratio is greater than or equal to the preset probability, it may be determined that the location information is correlated to the location where the consumption event occurs.

In 708, if the overlapping ratio is less than the preset probability, it may be determined that the location information is uncorrelated to the location where the consumption event occurs.

In some embodiments, the overlapping ratio between the first character string and the second character string may be determined based on the number count of characters or words (denoted as “n”) that are matched (e.g., exactly the same, or synonymic) in the first character string and the second character string. Specifically, the overlapping ratio may be equal to n divided by the total number count of the characters or words in the first character string or the second character string. The preset probability may be a default value of the payment management system 100 or may be set by an administrator (e.g., a system administrator responsible for managing the payment management system 100). For instance, the preset probability may be 0.45, 0.50, 0.55, 0.60, or more, or less.

For example, a user may initiate a payment request related to a business trip to Road C, City B, Province A (i.e., a prescribed geographical location), and an invoice for an accommodation consumption is provided, the amount of which is 500 yuan. “Road C, City B, Province A” is the second character string indicating the occurrence of the consumption event. The address of the entity that provides the invoice provided by the user is No. 13, Road C, City B, Province A, that is, the first character string representing the location information of the entity providing the invoice is “No. 13, Road C, City B, Province A”. In this case, the overlapping ratio between the first character string and the second character string is higher than 60%. For instance, the preset probability may be 50%, and the overlapping ratio may be greater than the preset probability. Therefore, for the accommodation consumption event of the user, it should be determined that the location information is correlated to the location where the consumption event occurs, and that the consumption event is valid. The payment request may be determined as eligible. 500 Yuan may be transacted to the financial account of the user.

If the address of the entity that issues the invoice provided by the user is “No. 15, Road E, City D, Province A”, the overlapping ratio between the character string is only 25%, which is less than the preset probability (e.g., 50%). Then, the location information of the entity that issues the invoice provided by the user is not related to the location where the consumption event occurs, and the accommodation consumption event of the user is deemed as invalid. The payment request may be determined as ineligible. A notification message may be sent to a requester terminal associated with the user to notify the user that the payment request is ineligible, and that the user may need to check information related to the service provided to the user and/or modify the payment request.

FIG. 8 is a flowchart illustrating a payment management process according to some exemplary embodiments of the present disclosure. The process 800 may be executed by the payment management system 100 shown in FIG. 1 or the payment management system 1000 shown in FIG. 10. For example, the process 800 may be implemented as a set of instructions (e.g., an application) stored in the storage (e.g., ROM 230 or RAM 240 of the computing device 200). The processing engine 112, the modules in FIG. 4 and/or units in FIG. 10 may execute the set of instructions, and when executing the instructions, the processing engine 112 and/or the modules may be configured to perform the process 800. The operations of the illustrated process 800 presented below are intended to be illustrative. In some embodiments, the process 800 may be accomplished with one or more additional operations not described, and/or without one or more of the operations discussed. Additionally, the order in which the operations of the process 800 as illustrated in FIG. 8 and described below is not intended to be limiting.

FIG. 8 provides an alternative determination process for determining whether the location information is correlated to the location where the consumption event occurs.

As shown in FIG. 8, determining whether the location information is correlated to the location where the consumption event occurs may include the following operations.

In 802, a first region related to the location information (i.e., the first geographical information) and a second region related to the location where the consumption event occurs may be determined.

In 804, an overlapping area (interchangeably referred to as an overlap) between the first region and the second region may be determined.

In 806, whether the overlapping area is less than a preset area may be determined.

In 808, if the overlapping area is less than the preset area, it may be determined that the location information is uncorrelated to the location where the consumption event occurs.

In 810, if the overlapping area is not less than (i.e., is greater than or equal to) the preset area, it may be determined that the location information is correlated to the location where the consumption event occurs.

As used herein, the first region may include a location of the entity of the service provider that issues the invoice (i.e., a first geographical location), and the second region may include a location where the consumption event occurs (i.e., a second geographical location). In some embodiments, the first region or the second region may be a residential community, a district, a town, a city, a province, or the like. In some embodiments, the first geographical location and the second geographical location may be represented by geographical coordinates. The first region may be a region within a predetermined distance from the geographical coordinates representing the first geographical location. The second region may be a region within a predetermined distance from the geographical coordinates representing the second geographical location. For instance, the predetermined distance may be 1 kilometer (km), 1.5 km, 2 km, or more, or less.

In some embodiments, the overlapping area may be a certain amount of area that is covered by both the first region and the second region. The preset area may be a preset amount of area, such as 200 square meter (m²), 500 m², 1000 m², 3000 m², or more, or less. In some embodiments, the overlapping area may be denoted as a ratio. For example, the ratio may be determined by dividing the area that is covered by both the first region and the second region by the area of the first region or the second region. In some embodiments, the preset area may be a preset ratio of overlapping area, such as 0.30, 0.35, 0.40.

By determining the first region related to the location information and the second region related to the location where the consumption event occurs, the overlapping area of the first region and the second region may be determined, and when the overlapping area is less than the preset area, it may be determined that the location information is uncorrelated to the location where the consumption event occurs. In this way, a determination basis is provided from the perspective of the actual geographical location and an area that covers the actual geographical location, and a quantitative criterion may be provided for the determination of whether the consumption event is valid. This may be conducive to implementing the electronic operation of the payment work. Additionally or alternatively, this method may reduce the labor intensity of the financial personnel of the company, and improve the work efficiency, the accuracy, and timeliness of their work. The process may also reduce the possibility of human error and/or arbitrary determination.

For example, if a user travels for a business trip to District B, City A, during which a taxi fare occurs, then after he returns to the company, he may initiate a payment request and provide a taxi invoice of 100 yuan, and the address of the entity that issues the invoice is District C, City A. Then District C, City A is the first region. Since the user travels for the business trip to District B, City A, the location where the consumption event occurs, or the second region, is District B, City A. Assuming that the overlapping area of the first region and the second region is 50%, which is larger than the preset area (e.g., 40%), the location information is deemed as being correlated to the location where the consumption event occurs. If the address of the entity that issues the taxi invoice provided by the user is City E, then the overlapping area of the first region and the second region is 0, which is less than the preset area. As such, the location information is deemed as being uncorrelated to the location where the consumption event occurs.

FIG. 9 is a flowchart illustrating a payment management process according to some exemplary embodiments of the present disclosure. The process 900 may be executed by the payment management system 100 shown in FIG. 1 or the payment management system 1000 shown in FIG. 10. For example, the process 900 may be implemented as a set of instructions (e.g., an application) stored in the storage (e.g., ROM 230 or RAM 240 of the computing device 200). The processing engine 112, the modules in FIG. 4 and/or units in FIG. 10 may execute the set of instructions, and when executing the instructions, the processing engine 112 and/or the modules may be configured to perform the process 900. The operations of the illustrated process 900 presented below are intended to be illustrative. In some embodiments, the process 900 may be accomplished with one or more additional operations not described, and/or without one or more of the operations discussed. Additionally, the order in which the operations of the process 900 as illustrated in FIG. 9 and described below is not intended to be limiting. According to another embodiment of the present disclosure, the payment management process may include the following operations for determining whether the location information is correlated to the location where the consumption event occurs.

In 902, a consumption category of the relevant consumption evidence (e.g., an invoice) may be determined.

In 904, whether a dwell time related to the location where the consumption event occurs is less than a preset time duration (i.e., a time threshold) corresponding to the consumption category may be determined.

In 906, if the dwell time of the location where the consumption event occurs is greater than or equal to the preset time duration corresponding to the consumption category, the payment may be executed.

In 908, if the dwell time of the location where the consumption event occurs is less than the preset duration corresponding to the consumption category, the processing engine 112 may determine not to execute the payment.

The consumption category may refer to the category of the service provided to the user. For instance, the consumption category may include accommodation, food and drink, transportation (e.g., taxi fares, train fares, or air fares), procurement, or the like, or any combination thereof. In some embodiments, services of different consumption categories may correspond to different preset dwell time. As used herein, the term “dwell time” refers to a time period during which the user stays at or near the location where the consumption event occurs. For instance, the preset time duration corresponding to accommodation may be associated with the number of nights for which the user stays in a hotel (e.g., one night, three nights). As another example, the preset time duration corresponding to transportation may include the number of hours needed for the transportation.

For instance, a user may travel to city A for a business trip and return on the same day, but he initiates a payment request and provides an accommodation invoice. Obviously, if the user takes a round trip on the same day, the accommodation consumption event occurs within 24 hours (from the time user leaves for city A). For the consumption category of accommodation, the preset time duration is at least 24 hours. Thus, the dwell time of the user is less than the preset duration, and the payment may not be executed. The payment request may be determined as ineligible.

As another example, for transportation from city A to city B, the preset time duration is 2 hours, and the user provides an invoice in which the travel time is 1 hour. The travel time is less than the preset time duration, and thus the payment may not be executed.

Through process 900, a more scientific and accurate determination process is provided for determining whether a continuous consumption is normal, which may reduce the possibility of incorrect determination and incorrect number count of reimbursement. Additionally or alternatively, this process may improve labor efficiency.

It should be noted that the above description regarding FIGS. 5-9 is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

FIG. 10 is a schematic block diagram illustrating a payment management system according to some exemplary embodiments of the present disclosure. In some embodiments, the payment management system 1000 may be implemented on the processing engine 112. The processing engine 112 may be in communication with a storage medium (e.g., the storage device 140 of the payment management system 100, and/or the storage 390 of the terminal device 300), and may execute instructions stored in the storage medium. For instance, the payment management system 1000 may be configured to perform the process 500, 600, 700, 800, and/or 900 shown in FIGS. 5-9, respectively. As shown in FIG. 10, according to some embodiments of the present disclosure, a payment management system 1000 is provided. The payment management system 1000 may include an information receiving unit 1010, a location obtaining unit 1020, and a determination unit 1030.

When the payment management is performed, the information receiving unit 1010 may receive the payment request and a relevant consumption evidence (e.g., an invoice related to a service provided to a user). The consumption evidence may include the location information of the entity of a service provider that provides the relevant consumption evidence. Thus, the location information of the entity that provides the evidence may be obtained. In many cases, the location information of the entity providing the relevant consumption evidence may be the location where the consumption event occurs. Therefore, the obtaining of the location information of the entity providing the evidence may provide a basic condition for the identification of the validity of the consumption event. Further, the location where the consumption event occurs may be obtained by the location obtaining unit 1020, and may be compared with the location information of the entity that provides the evidence. The determination unit 1030 may determine whether the location information is correlated to the location where the consumption event occurs. If the location information is uncorrelated to the location where the consumption event occurs, the consumption event may be determined as invalid. This may be caused by a mistake made by the user or a false consumption event provided by the user. For the invalid consumption event, no payment may be executed. Through the payment management system 1000 of the present disclosure, a determination basis for the validity of the consumption event may be provided. The possibility of false determination regarding the validity of the consumption events caused by the human operation may be reduced. The error rate of the payment work may be reduced, and the possibility of payment for an invalid consumption event may also be reduced.

Specifically, if a user initiates a payment request for a meal fee, the amount of the meal fee, the name of the restaurant, and the address of the restaurant may be received by the information receiving unit 1010. The address of the restaurant may be a location A. The location obtaining unit 1020 may obtain a location B where the consumption event occurs based on, for example, the information provided by the user, and/or positioning information of a mobile terminal carried by the user. The determination unit 1030 may determine that the occurrence of the consumption event is B, and then the determination unit 1030 may determine that A and B are not the same location. Therefore, the determination unit 1030 may determine that the location information of the meal is not correlated to the location where the consumption event occurs. The consumption event is determined to be invalid. This process may reduce the possibility of false reimbursement, improve work efficiency, thereby improving the accuracy of the review of payments and reducing the labor intensity of the financial personnel.

Further, the determination unit 1030 may specifically include a character determination sub-unit 1040 and a first execution sub-unit 1050.

In some embodiments, the first character string related to the location information and the second character string related to the location where the consumption event occurs may be determined by the character determining sub-unit 1040. The first execution sub-unit 1050 may determine the overlapping ratio between the first character string and the second character string. If the overlapping ratio is less than the preset probability, the first execution sub-unit 1050 may determine that the location information is uncorrelated to the location where the consumption event occurs. That is to say, from the perspective of the names of the geographical locations, the process provides a quantitative standard for the determination of whether the consumption event is eligible. This may be conducive to the implementation of the electronic operation of the payment work, reducing the labor intensity of the financial personnel of the company, improving the work efficiency, the accuracy, and timeliness of the work, and reducing the possibility of human error or arbitrary determination.

In some embodiments, the determination unit 1030 may further include a region determination sub-unit 1060 and a second execution sub-unit 1070.

The first region of the location information and the second region of the location where the consumption event occurs may be determined by the region determination sub-unit 1060. By the second execution sub-unit 1070, an overlapping area of the first region and the second region may be determined, and if the overlapping area is less than the preset area, it may be determined that the location information is uncorrelated to the location where the consumption event occurs. That is to say, the determination basis may be provided from the perspective of the actual geographical location and an area that covers the geographical location, and a quantitative criterion is provided for the determination of whether the consumption event is valid. This may be conducive to implementing the electronic operation of the payment work. Additionally or alternatively, this process may reduce the labor intensity of the financial personnel of the company, improving the work efficiency, the accuracy, and timeliness of their work. The process may also reduce the possibility of human error and/or arbitrary determination.

In some embodiments, the determination unit 1030 may further include a category determination sub-unit 1080 and a payment rejection sub-unit 1090.

The determination sub-unit 1080 may determine the consumption category of the relevant consumption evidence, and may roughly determine a general consumption duration of the consumption category, also referred to as a preset time duration. If the dwell time of the location where the consumption event occurs is less than the preset time duration corresponding to the consumption category, the payment rejection sub-unit 1090 may determine that the user does not have a consumption event at this location, or that the consumption time is substantially reduced. This consumption event may be inconsistent with normal consumption events. Therefore, the consumption event is highly likely to be an invalid consumption event, and the payment may not be executed. This process may improve the efficiency of payment management and the accuracy of determination, and improve the convenience related to the electronic operations.

Specifically, a user may travel to a place A for a business trip, and the user may request for a payment for accommodation. It may be predetermined that the travel time is 3 days, that is, the preset time duration is 3 days. But by the positioning of a mobile terminal or other consumption evidence (e.g., an invoice), it is found that the user actually stayed for only one night in place A. That is, the dwell time of the location where the consumption event occurs is less than the preset time duration. Thus, it may be determined that the consumption event of the user is invalid. The payment may not be executed, and the payment request may need to be modified or withdrawn.

The units in FIG. 10 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. In some embodiments, two or more of the modules may be combined into a single module, and any one of the modules may be divided into two or more units.

FIG. 11 is a schematic diagram illustrating a payment management system according to some exemplary embodiments of the present disclosure. This embodiment, in combination with the fore-mentioned embodiments, provides a computing device 1120, as shown in FIG. 11, for controlling the payment management system 1000. The computing device 1120 may include a processor 1130, and a storage 1110 served as a computer readable storage medium in which a computer program corresponding to the payment management method may be stored. By reading and executing the computer program on the computing device 1120, the payment management method may be executed to enable the payment management system 1000 to perform the electronic operation of payment management. In this way, the automation degree of the payment work and the work efficiency may be improved, and the possibility of false reimbursement may be reduced.

The payment management method provided by the present disclosure is described in detail above with reference to the accompanying drawings. Through the method, quantitative standards for payment management are provided, which may facilitate the electronic operation of payment management, and effectively improve the convenience and accuracy of payment management. Additionally or alternatively, this method may improve work efficiency, reduce labor intensity, and reduce the possibility of false payments.

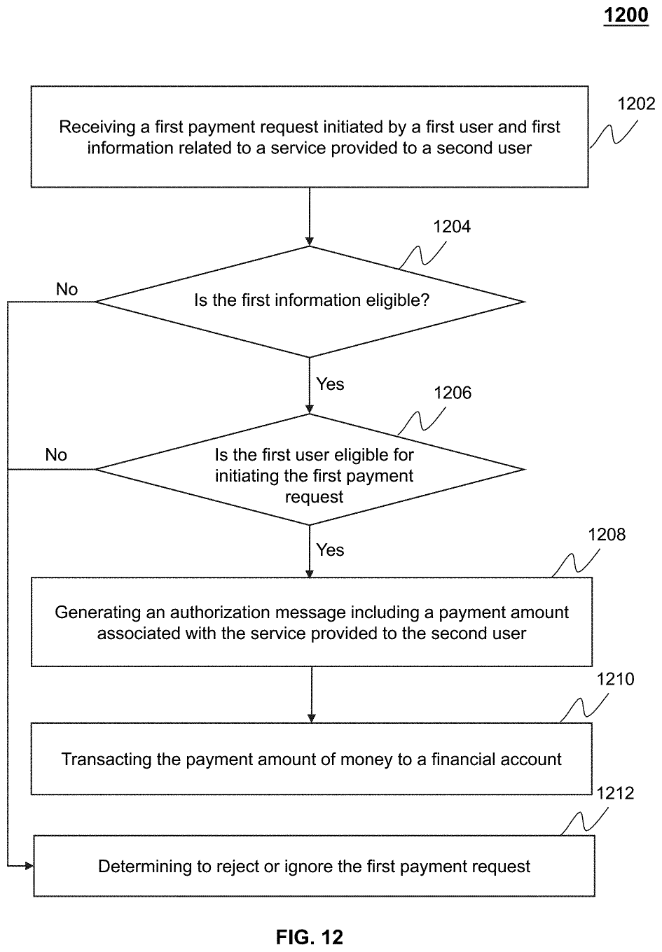

FIG. 12 is a flowchart illustrating an exemplary process for payment management according to some exemplary embodiments of the present disclosure. The process 1200 may be executed by the payment management system 100. For example, the process 1200 may be implemented as a set of instructions (e.g., an application) stored in the storage (e.g., ROM 230 or RAM 240 of the computing device 200). The processing engine 112, the modules in FIG. 4 and/or units in FIGS. 16-18 may execute the set of instructions, and when executing the instructions, the processing engine 112 and/or the modules may be configured to perform the process 1200. The operations of the illustrated process 1200 presented below are intended to be illustrative. In some embodiments, the process 1200 may be accomplished with one or more additional operations not described, and/or without one or more of the operations discussed. Additionally, the order in which the operations of the process 1200 as illustrated in FIG. 12 and described below is not intended to be limiting.

In 1202, the processing engine 112 (e.g., the obtaining module 410) may receive a first payment request initiated by a first user and first information related to a service provided to a second user. In some embodiments, the first payment request may be associated with a service provided to the second user for a business reason. The second user may have paid a fee for the service. The first user may initiate a payment request to allow the second user to get paid back (i.e., as a reimbursement) by a person or an organization (e.g., a company that hires the user). In some embodiments, the first user may initiate the first payment request on behalf of the second user (i.e., as a proxy of the second user) via a first requester terminal (e.g., the user terminal 130). If the payment request is determined to be approved (i.e., eligible), a certain amount of money corresponding to the service may be paid to the second user. In some embodiments, the payment request may be associated with a payment for a service provided by the first user to the second user (i.e., a service requester). The service requester or a service provider may initiate the payment request. For instance, if the payment request initiated by the service requester or the service provider is approved, an amount of money may be paid to the service provider.

In some embodiments, the service may include but not limited to an accommodation service, a food and drink service, a transportation service, or the like, or any combination thereof. The processing engine 112 may determine one or more first parameters based on the first information related to the service, such as the time when the service is provided to the second user, the location where the service is provided to the second user, the fee paid for the service, the duration of the service, a payment amount, or the like, or any combination thereof.

In some embodiments, the second user may initiate a second payment request via a second requester terminal by himself/herself. The processing engine 112 may further collect second information related to the service provided to the second user.

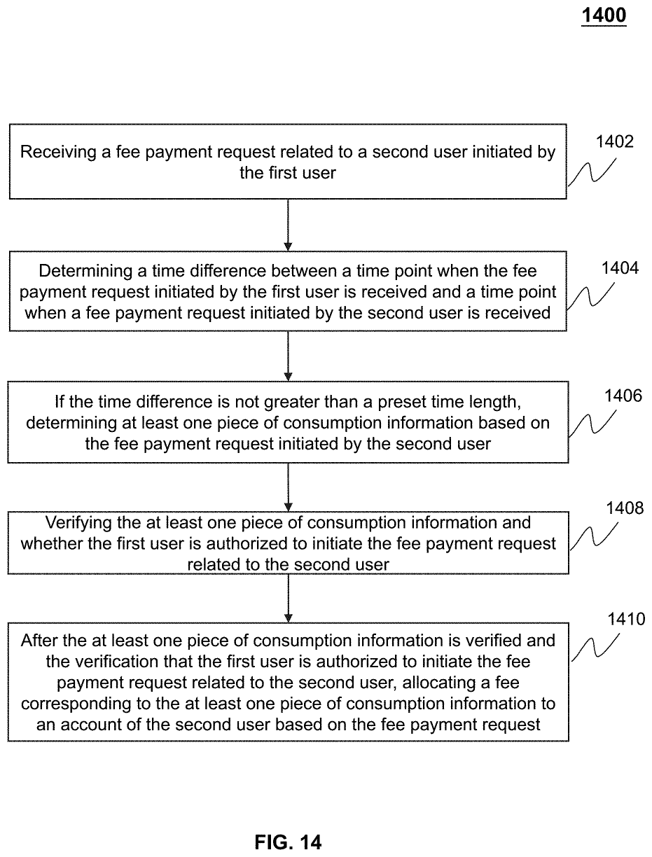

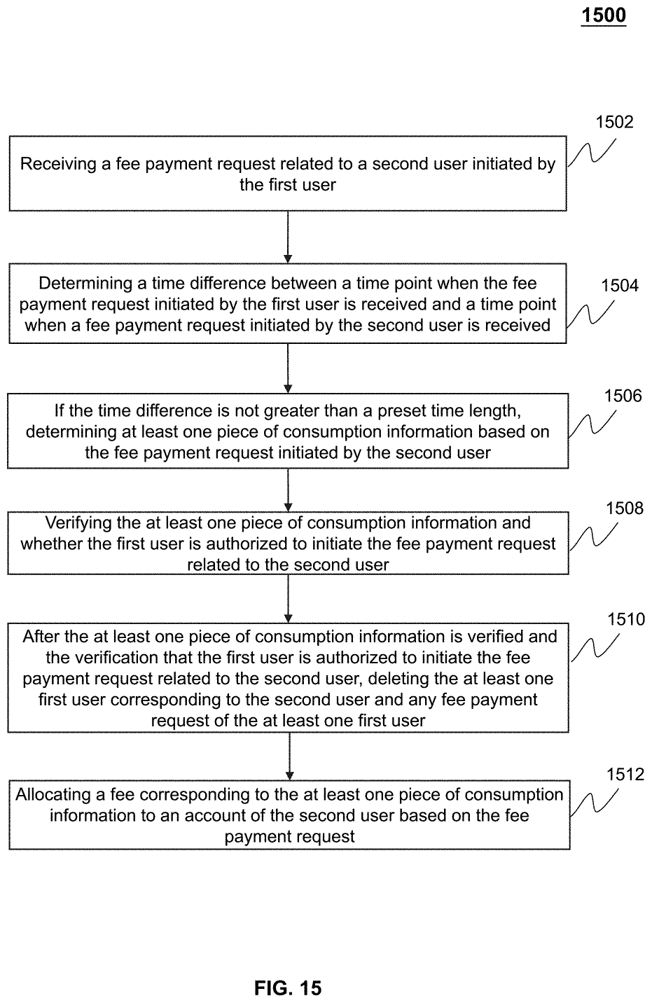

In 1204, the processing engine 112 (e.g., the determination module 420) may determine whether the first information is eligible. The processing engine 112 may generate a first verification result by verifying the first information according to a first preset rule. In some embodiments, the processing engine 112 may determine whether the first payment request is eligible to be approved based on the first information related to the service provided to the second user. Specifically, the processing engine 112 may determine one or more first parameters based on the first information related to the service. For the one or more first parameters, the processing engine 112 may determine one or more first matching degrees based on a first database. The processing engine 112 may further determine whether the first matching degree(s) is greater than corresponding first matching degree threshold(s). In response to a determination that at least one of the first matching degree(s) associated with the one or more first parameters is greater than the corresponding first matching degree threshold(s), the processing engine 112 may verify that the first information is eligible, i.e., the first information is successfully verified. The process 1200 may proceed to operation 1206. In response to a determination that at least one of the one or more first matching degrees are less than or equal to one or more corresponding first matching degrees, the processing engine 112 may determine that the first payment request is not eligible. The process 1200 may proceed to operation 1212. More details regarding the verification of the first payment request may be found elsewhere in the present disclosure, for example, in FIG. 14, FIG. 15, and/or the description thereof.

In 1206, the processing engine 112 (e.g., the determination module 420) may determine whether the first user is eligible for initiating the first payment request. The processing engine 112 may generate a second verification result by verifying whether the first user is authorized to initiate the first payment request according to a second preset rule. The processing engine 112 may determine whether the first payment request is approved at least based on the first verification result and the second verification result. For example, in response to a determination that the first information is eligible and that the first user is eligible for initiating the first payment request, the processing engine 112 may determine that the first payment request is eligible to be approved.

For instance, the processing engine 112 may obtain proxy information related to the first user and/or the second user from a storage device (e.g., the storage device 140 of the payment management 140). The proxy information may indicate whether the first user is eligible for representing the second user (e.g., to initiate the first payment request). In response to a determination that the first user is eligible for representing the second user, the process 1200 may proceed to operation 1208. In response to a determination that the first user is not eligible for representing the second user, the process 1200 may proceed to operation 1212.

In some embodiments, the processing engine 112 may receive both the first payment request initiated by the first user and the second payment request initiated by the second user. In some embodiments, the processing engine 112 may determine a time difference between a first time point associated with the first payment request and a second time point associated with the second reimbursement. Specifically, the first time point may be a time point when the first reimbursement is received and the second time point may be a time point when the second reimbursement is received. The processing engine 112 may further compare the time difference with a preset time. In response to a determination that the time difference is less than the preset time, the processing engine 112 may verify that the first user is not eligible for initiating the first payment request. In this case, the first payment request and the second payment request may correspond to the same service provided to the second user. In order to avoid paying twice for the same service for reimbursement, the processing engine 112 may reject and/or ignore the first payment request.

In some embodiments, the processing engine 112 may further generate a third verification result by verifying the second information according to a third preset rule. The processing engine 112 may determine whether the second payment request is eligible to be approved at least based on the third verification result. The processing engine 112 may further determine whether the second payment request is eligible in a manner similar to operation 1204. Specifically, the processing engine 112 may determine one or more second parameters based on the second information related to the service of the second payment request and verify whether the second payment request is eligible based on the one or more second parameters.

In 1208, the processing engine 112 (e.g., determination module 420) may generate an authorization message including a payment amount associated with the service provided to the second user. If the first payment request is eligible to be approved, the processing engine 112 may determine the payment amount based on the first information related to the service of the first payment request. If the second payment request is eligible, the processing engine 112 may determine the payment amount based on the second information related to the service of the second payment request.

In 1210, the processing engine 112 (e.g., the transaction module 430) may transact the payment amount of money to a financial account. In some embodiments, the payment request may be associated with a reimbursement. The payment amount of money may be transacted to the financial account of the second user. In some embodiments, the first user may not be allowed to change the financial account for receiving the payment amount corresponding to the first payment request, which may decrease the risk of property loss for the second user. In some embodiments, the payment request may be associated with a payment for the service provided to the second user. The payment amount of money may be transacted to the financial account of the first user (e.g., a service provider).

The financial account of the first user or the second user may include, for example, a bank account, or a third-party electronic account such as an account of the WeChat wallet, Alipay, PayPal, or the like. In some embodiments, the payment amount may be transacted to the financial account of the first user or the second user by the financial personnel.

In 1212, the processing engine 112 may determine to reject or ignore the first payment request. The first requester terminal may provide a modification option to the first user. The first user may modify incorrect information related to the first payment request and resubmit the first payment request. Alternatively, the first user may withdraw the first payment request.

It should be noted that the above description of FIG. 12 is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure. It should be noted that operation 1204 and operation 1206 may be performed simultaneously or sequentially in any order. For example, the processing engine 112 may firstly determine whether the first user is eligible for representing the second user, and then determine whether the first information is eligible.

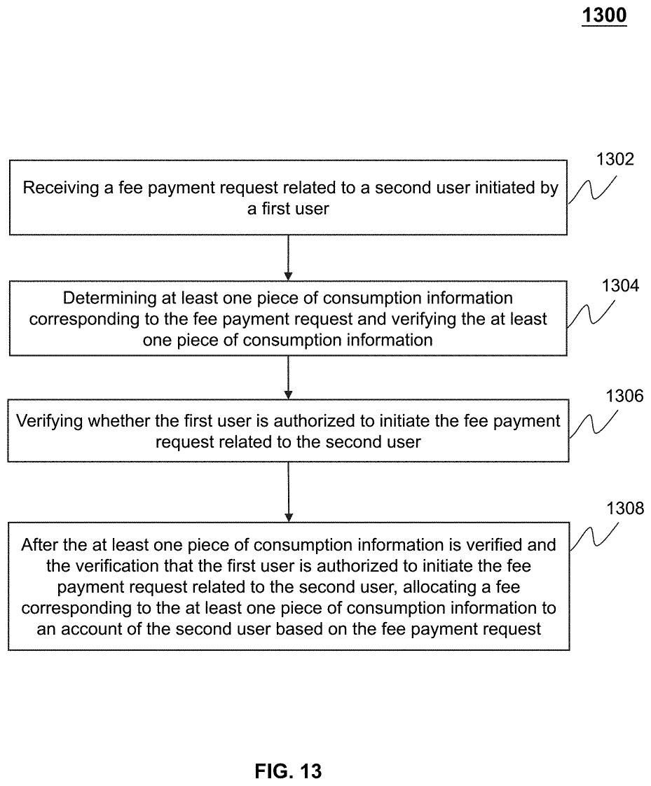

FIG. 13 is a flowchart illustrating a fee payment management process according to some exemplary embodiments of the present disclosure. The process 1300 may be executed by the payment management system 100. For example, the process 1300 may be implemented as a set of instructions (e.g., an application) stored in the storage (e.g., ROM 230 or RAM 240 of the computing device 200). The processing engine 112, the modules in FIG. 4 and/or units in FIGS. 16-18 may execute the set of instructions, and when executing the instructions, the processing engine 112 and/or the modules may be configured to perform the process 1300. The operations of the illustrated process 1300 presented below are intended to be illustrative. In some embodiments, the process 1300 may be accomplished with one or more additional operations not described, and/or without one or more of the operations discussed. Additionally, the order in which the operations of the process 1300 as illustrated in FIG. 13 and described below is not intended to be limiting. As shown in FIG. 13, a process for fee payment management may include the following operations.

In 1302, a fee payment request (interchangeably referred to as a payment request) related to a second user initiated by a first user may be received.

In 1304, at least one piece of consumption information corresponding to the fee payment request may be determined and verified.

In 1306, whether the first user is authorized to initiate the fee payment request related to the second user may be verified.

In 1308, after the at least one piece of consumption information is verified and the verification that the first user is authorized to initiate the fee payment request related to the second user, a fee corresponding to the at least one piece of consumption information may be allocated to an account of the second user based on the fee payment request.

In some embodiments, in 1302, a fee payment request related to the second user initiated by the first user may be received, which is also interchangeably referred to as a first payment request. The fee payment request may correspond to a consumption event of the second user. A fee related to the consumption event may be reimbursed, for example, by a person or an organization that hires the second user (e.g., a company, a government department). For instance, the consumption event may be related to a service provided to the second user, including but not limited to an accommodation service, a food and drink service, a transportation service, or the like, or any combination thereof. In some embodiments, the first user may further provide a consumption evidence related to the consumption event, such as a receipt, a transaction record, or the like, or any combination thereof. In 1304, at least one piece of consumption information corresponding to the fee payment request may be determined and verified, thereby preventing the payment for a nonexistent consumption and avoiding a property loss. As used herein, the at least one piece of consumption information may refer to information related to the service provided to the second user. For instance, the at least one piece of consumption information may include a consumption category of the service, an amount of fee related to the service, time of the service, a location of the service, a duration of the service, a consumption evidence, or the like, or any combination thereof. The nonexistent consumption refers to a piece of false consumption information caused by mistakes in the fee payment request or a consumption event that didn't occur (i.e., a fake consumption event). In 1306, the verification of whether the first user is authorized to initiate the fee payment request related to the second user may avoid misoperations or cheating, and reduce a possibility of the second user's payment fee to be encroached by the first user. In 1308, after both of the verifications are successfully performed, that is, when the consumption information corresponding to the fee payment request is authentic and the first user is authorized to represent the second user to initiate a fee payment request, a fee corresponding to the at least one piece of consumption information may be allocated to the account of the second user based on the fee payment request, and thus a fee payment process may be completed. It may be understood that the account corresponding to the second user may be a bank account, or a third-party electronic account such as an account from the WeChat wallet, Alipay, PayPal, or the like. It should be noted that the first user representing the second user may not be allowed to give an instruction to change the account for receiving the fee corresponding to the fee payment request, so as to ensure the security of the payment.

As used herein, the second user refers to a person who generates the consumption information (i.e., a person to whom the service is provided), and the first user refers to a person that is authorized by the second user, also referred to as a proxy of the second user. In order to reduce the repetitiveness of the process, the second user (i.e., the person who generates the consumption information) may designate one or more first users to be a proxy, and the one or more first users may deal with the reimbursement process on behalf of the second user. It should be noted that the first user may not be allowed to give an instruction to change the account for receiving the fee related to the fee payment request, so as to ensure the security of the payment.

In addition, it may be understood that there may be multiple pieces of consumption information in a fee payment request, and different consumption information may correspond to different second users. In some embodiments, more than one second user may designate the same first user as a proxy for initiating the fee payment request. Therefore, the first user, as a proxy, may perform the fee payment procedures for multiple second users.

It should be noted that the above description of FIG. 13 is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

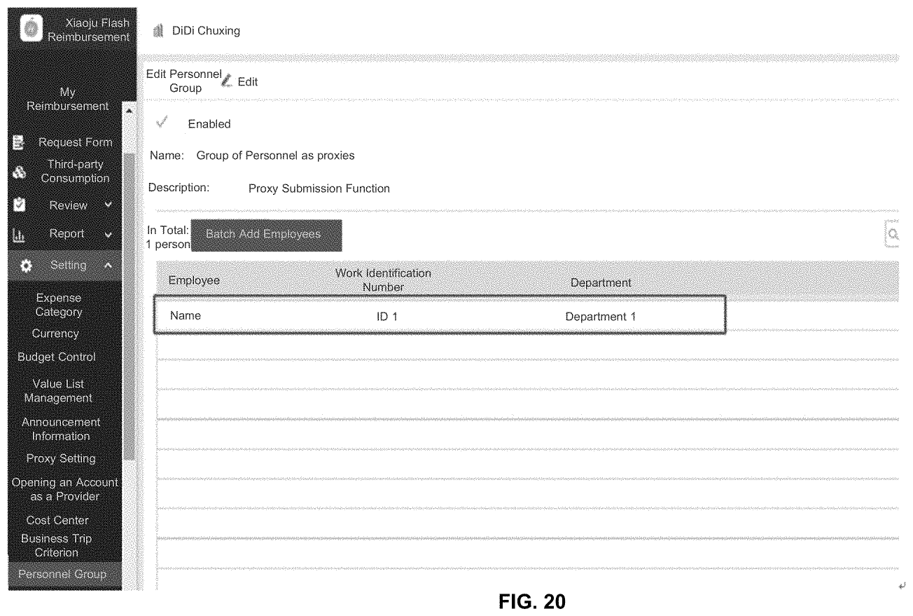

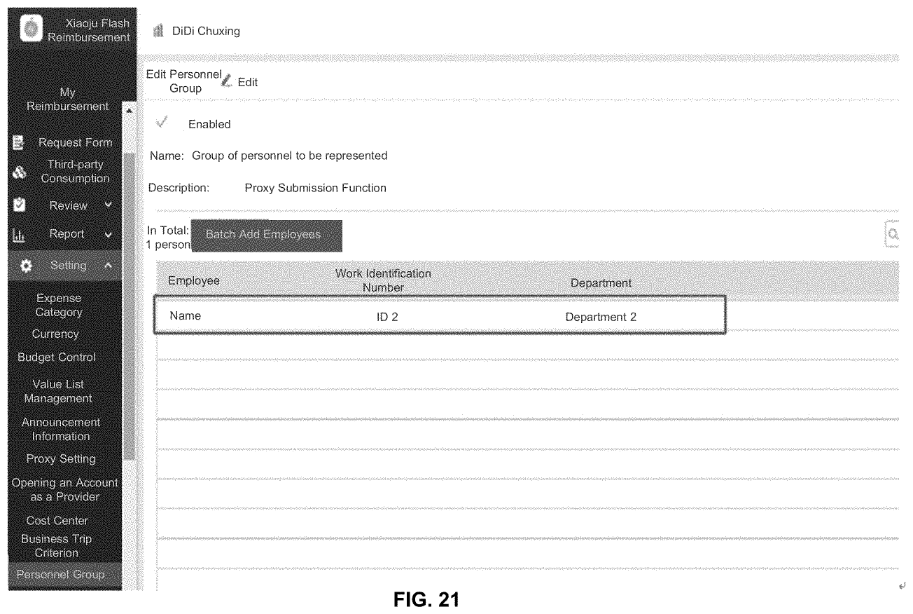

FIG. 20 is a schematic diagram illustrating a terminal interface of pre-adding a first user in the fee payment management according to some exemplary embodiments of the present disclosure. FIG. 21 is a schematic diagram illustrating a terminal interface of pre-adding a second user in the fee payment management according to some exemplary embodiments. The terminal interface may be displayed on a terminal device, such as a table-top computer, a lap-top computer, a tablet computer, or the like. In some embodiments, according to a preset process, as shown in FIG. 20 and FIG. 21, the second user and the first user may be added to the payment management system 100 by the administrator. For instance, an administrator may add the first user in a personnel group named “Group of Personnel as proxies”. Information related to the first user may be inputted via the interface, such as the name of the first user, the work identification number of the first user, the department of the first user, etc. The administrator may batch add a plurality of first users as proxies that are allowed to initiate a fee payment request on behalf of one or more second users. The second user may be added in the personnel group named “Group of Personnel to be represented”. Similarly, the administrator may input information related to the second user. The administrator may batch add a plurality of second users to be represented by the first user(s).

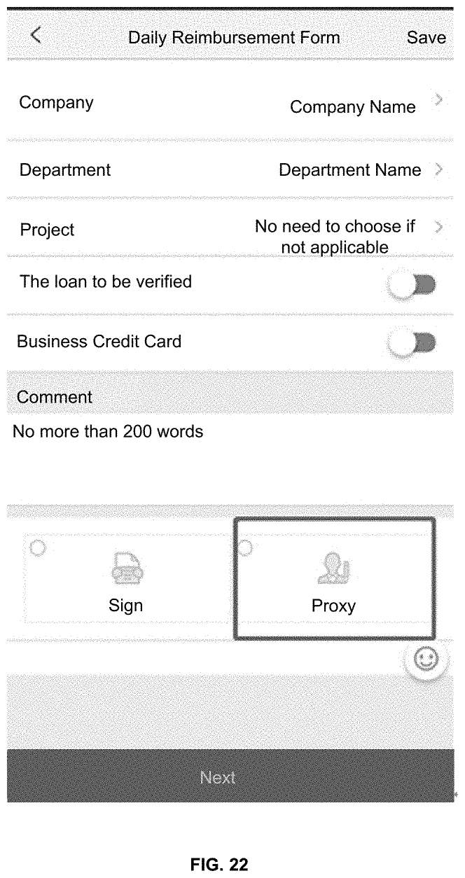

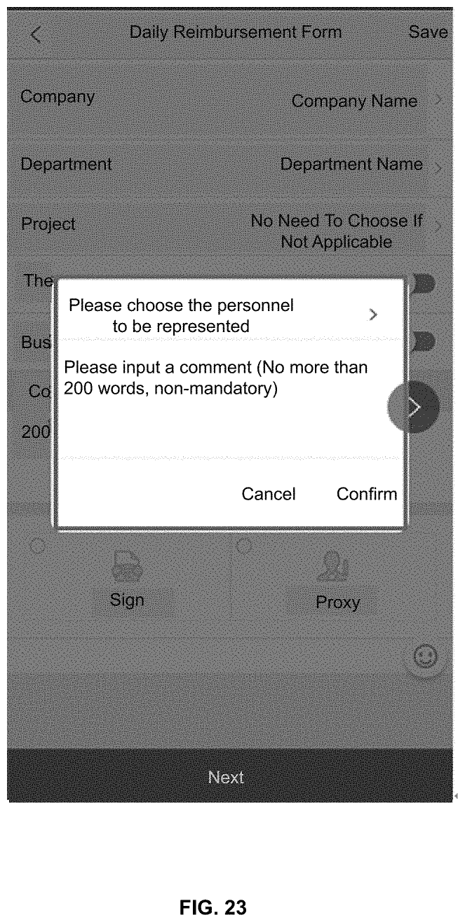

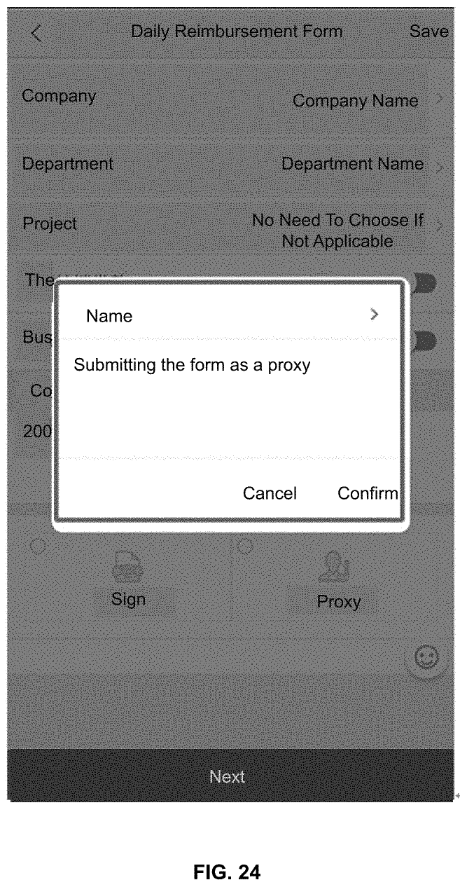

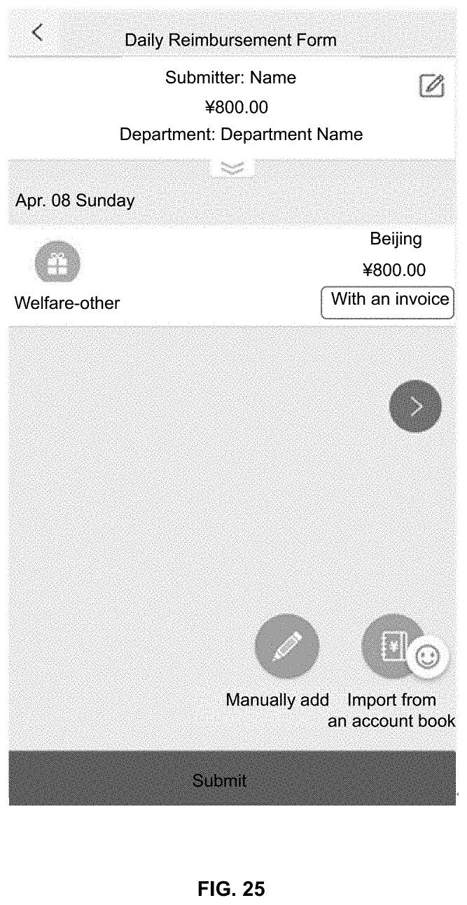

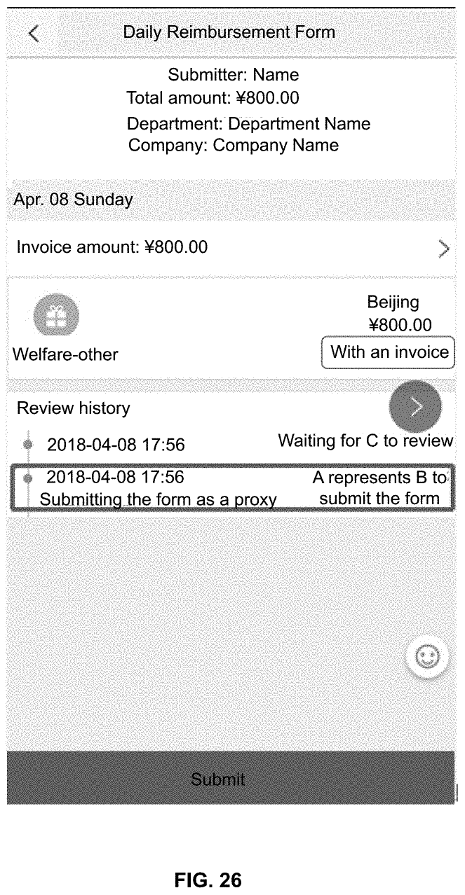

FIGS. 22-26 are schematic diagrams illustrating exemplary interfaces of a terminal application (APP) related to a fee payment management according to some exemplary embodiments of the present disclosure. The terminal APP may be installed on a terminal device (e.g., the user terminal 130). A first user may provide information related to a fee payment request on the interface shown in FIG. 22 to generate a reimbursement form. For instance, the information related to the fee payment request may include the company name, the department name, the project, etc. After filling in the information on the top part of the terminal interface, the first user may click the “proxy” button at the bottom right part of the interface, as shown in FIG. 23. The pop-up box in the middle of the terminal interface may be used for the selection (or input) of a user to be represented (i.e., the second user). The first user may also add a comment related to the fee payment request to provide additional information related to the fee payment request. After selecting the second user to be represented, the first user may click on the “Confirm” button to proceed to the next operation, or click on the “Cancel” button to modify the information related to the fee payment request. As shown in FIG. 24, after the first user clicks on the “Confirm” button, the corresponding proxy information may be displayed on the terminal interface. The first user may select or input his/her own name, and click on the “Confirm” button and the “Next” button to proceed to the next operation. As shown in FIG. 25, the terminal interface may display the submission information of the first user, including the name, the department, etc., and the terminal interface may also show the payment amount. Brief information related to the reimbursement form may also be displayed, such as the date of filling the reimbursement form, a reimbursement category (e.g., welfare-other), a payment amount, a location, with/without an invoice, etc. After clicking the “submit” button at the bottom, the terminal interface may be displayed as shown in FIG. 26. The review history of the reimbursement form may be displayed below for viewing. Specifically, the review history may include a time and a status related to the reimbursement form. For instance, the review history may show that at 17:56 on Apr. 8, 2018, A (e.g., the name of the first user) represents B (e.g., the name of the second user) to submit the reimbursement form, and that the reimbursement form is waiting for C (e.g., the finance staff, the department manager) to review.

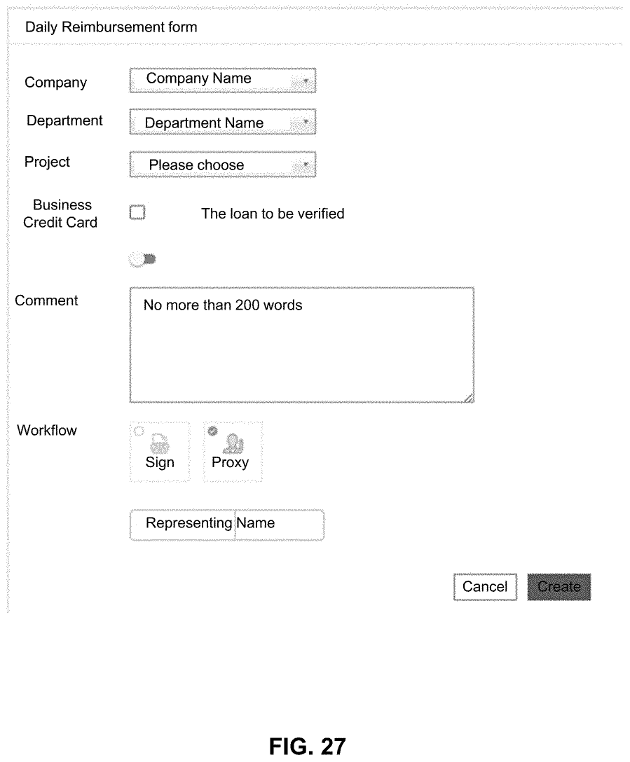

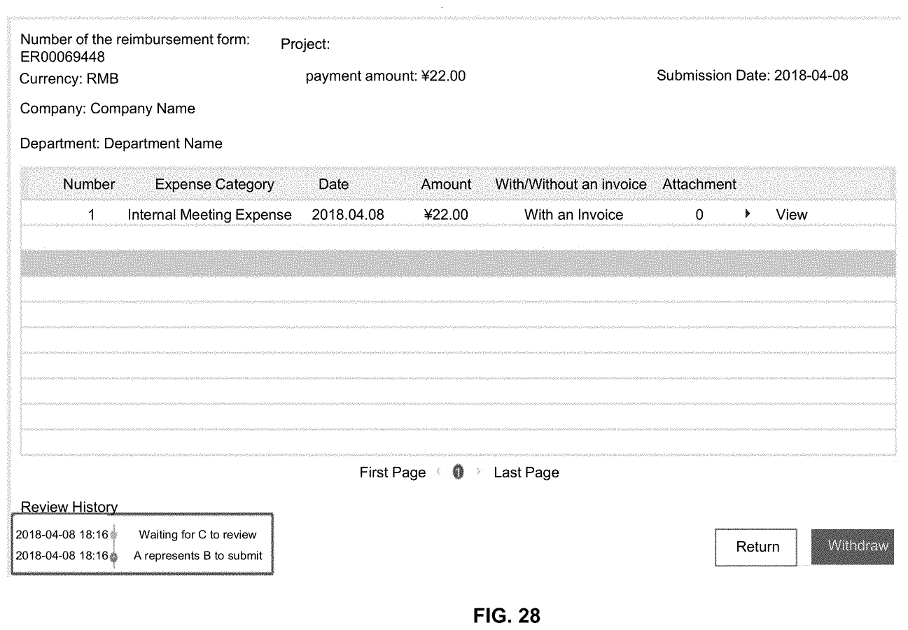

FIGS. 27-28 are schematic diagrams illustrating exemplary computer interfaces related to the fee payment management according to some exemplary embodiments of the present disclosure. A first user may provide information related to a fee payment request on the computer interface shown in FIG. 27 to generate a reimbursement form. For example, the information related to the fee payment request may include the company name, the department name, the project, etc. The first user may click on the “proxy” button to create a new reimbursement form after adding the person to be represented (i.e., the second user). As shown in FIG. 28, the first user may modify the amount of the fee and submit this reimbursement form. Similarly, the review history may be displayed in the lower left corner of the interface for viewing.

It should be noted that the above description regarding FIGS. 20-28 is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure. For instance, the graphs and words in the interface associated with the fee payment management system implemented on a terminal device may look different from the interfaces shown in FIGS. 20-28. As another example, more functions or fewer functions may be implemented via the interface.

FIG. 14 is a flowchart illustrating a fee payment management process according to some exemplary embodiments of the present disclosure. The process 1400 may be executed by the payment management system 100. For example, the process 1400 may be implemented as a set of instructions (e.g., an application) stored in the storage (e.g., ROM 230 or RAM 240 of the computing device 200). The processing engine 112, the modules in FIG. 4 and/or units in FIGS. 16-18 may execute the set of instructions, and when executing the instructions, the processing engine 112 and/or the modules may be configured to perform the process 1400. The operations of the illustrated process 1400 presented below are intended to be illustrative. In some embodiments, the process 1400 may be accomplished with one or more additional operations not described, and/or without one or more of the operations discussed. Additionally, the order in which the operations of the process 1400 as illustrated in FIG. 14 and described below is not intended to be limiting. As shown in FIG. 14, a process for fee payment management may include the following operations.

In 1402, a fee payment request related to a second user initiated by the first user may be received.

In 1404, a time difference between a time point when the fee payment request initiated by the first user (i.e., the first payment request) is received and a time point when a fee payment request initiated by the second user (i.e., the first payment request) is received may be determined.

In 1406, if the time difference is not greater than a preset time length, at least one piece of consumption information may be determined based on the fee payment request initiated by the second user.

In 1408, the at least one piece of consumption information and the proxy of the first user may be verified.

In 1410, after the at least one piece of consumption information is verified and the verication that the first user is authorized to initiate the fee payment request related to the second user, a fee corresponding to the at least one piece of consumption information may be allocated to an account of the second user based on the fee payment request.

In some embodiments, in 1402, a fee payment request related to the second user initiated by the first user may be received. The fee payment request may be related to a service provided to the second user. A fee payment request initiated by the second user may also be received. In 1404, a time difference between a time point when the fee payment request initiated by the first user is received and a time point when a fee payment request initiated by the second user is received may be determined. In 1406, if the time difference is not greater than (i.e., is less than or equal to) the preset time length, at least one piece of consumption information may be determined based on the fee payment request initiated by the second user. If the time point of receiving the first payment request is close to the time point of receiving the second payment request, the first payment request and the second reimbursement may correspond to the same service provided to the second user. This may cause the fee related to the service provided to the second user to be paid for reimbursement for twice. Therefore, the at least one piece of consumption information may be determined based on the second payment request. The first payment request may be rejected. The preset time length may be, for example, three days, a week, two weeks, a month, or the like. The preset time length may be a default value of the payment management system 100 or set by the administrator. In 1408, the at least one piece of consumption information and whether the first user is authorized to initiate the fee payment request related to the second user may be verified, thereby preventing the payment of a nonexistent consumption and avoiding a property loss. In 1410, after the at least one piece of consumption information and whether the first user is authorized to initiate the fee payment request related to the second user are successfully verified, the fee corresponding to the at least one piece of consumption information may be allocated to the account of the second user based on the fee payment request. The fee payment process may be controlled by the consumer user (i.e., the second user), thus ensuring the security of the payment. Specifically, the first user, as a proxy, may not be allowed to give an instruction to change the account for receiving the fee related to the fee payment request.

FIG. 15 is a flowchart illustrating a fee payment management process according to some exemplary embodiments of the present disclosure. The process 1500 may be executed by the payment management system 100. For example, the process 1500 may be implemented as a set of instructions (e.g., an application) stored in the storage (e.g., ROM 230 or RAM 240 of the computing device 200). The processing engine 112, the modules in FIG. 4 and/or units in FIGS. 16-18 may execute the set of instructions, and when executing the instructions, the processing engine 112 and/or the modules may be configured to perform the process 1500. The operations of the illustrated process 1500 presented below are intended to be illustrative. In some embodiments, the process 1500 may be accomplished with one or more additional operations not described, and/or without one or more of the operations discussed. Additionally, the order in which the operations of the process 1500 as illustrated in FIG. 15 and described below is not intended to be limiting.

As shown in FIG. 15, a process for fee payment management includes the following operations.

In 1502, a fee payment request related to a second user initiated by the first user may be received.

In 1504, a time difference between a time point when the fee payment request initiated by the first user (i.e., the first payment request) is received and a time point when a fee payment request initiated by the second user (i.e., the first payment request) is received may be determined.

In 1506, if the time difference is not greater than a preset time length, at least one piece of consumption information may be determined based on the fee payment request initiated by the second user.

In 1508, the at least one piece of consumption information and whether the first user is authorized to initiate the fee payment request related to the second user may be verified.

In 1510, after the at least one piece of consumption information is verified and the verification that the first user is authorized to initiate the fee payment request related to the second user. The information of the at least one first user corresponding to the second user and any/or the fee payment request of the at least one first user may be deleted.

In 1512, a fee corresponding to the at least one piece of consumption information may be allocated to an account of the second user based on the fee payment request.

In some embodiments, in 1502, a fee payment request related to a second user initiated by the first user may be received. The fee payment request may be related to a service provided to the second user. In 1504, a time difference between a time point when the fee payment request initiated by the first user is received and a time point when a fee payment request initiated by the second user is received may be determined. In 1506, if the time difference is not greater than a preset time length, at least one piece of consumption information may be determined based on the fee payment request initiated by the second user (i.e., the second payment request). If the time difference is greater than the preset time length, the processing engine 112 may determine the at least one piece of consumption information based on the fee payment request initiated by the first user (i.e., the first information). In 1508, the at least one piece of consumption information and whether the first user is authorized to initiate the fee payment request related to the second user may be verified, thereby preventing the payment of a nonexistent consumption and avoiding a property loss. Additionally or alternatively, this may prevent misoperations or cheatings by the first user, and avoid the possibility of the fee related to the second user to be encroached by the first user. In 1510, after the at least one piece of consumption information and whether the first user is authorized to initiate the fee payment request related to the second user are successfully verified, the information of the at least one first user corresponding to the second user and any fee payment request of the at least one first user may be deleted. In other words, the proxy of the first user to represent the second user to initiate or modify a fee payment request may be cancelled by the payment management system 100. In some embodiments, the proxy of the first user may remain cancelled for a certain time period (e.g., a week or a month) and then automatically become valid again after the certain time period. In some embodiments, the proxy of the first user may remain cancelled until the proxy is re-designated to the first user by the administrator or the second user. Any fee payment request of the first user may also be deleted by the payment management system 100. At this stage, only the second user may have the right to modify the second payment request in the fee payment process, and thus the possibility that the fee related to the second user to be encroached by the first user may be decreased. In 1512, the fee corresponding to the at least one piece of consumption information may be allocated to the account of the second user based on the fee payment request. Since the fee payment request is controlled by the consumer user (i.e., the second user), the security of the payment may be ensured.

The at least one piece of consumption information may be further verified, which may specifically include: determining at least one consumption parameter related to the consumption information, determining a matching degree of each of the at least one consumption parameter based on a consumption system database storing the at least one piece of consumption information. If all the matching degrees are greater than the corresponding matching thresholds, the verification may be determined as successful (i.e., the at least one piece of consumption information is authentic); otherwise, the verification may be determined as failed (i.e., the at least one piece of consumption information is inauthentic). The consumption parameter may include but not limited to a consumption time, a consumption location, a consumption category, a consumption duration, an amount of the fee, or the like, or a combination thereof.

In some embodiments, the verification of the at least one piece of consumption information may specifically include determining at least one consumption parameter related to the consumption information, and determining a matching degree for each of the at least one consumption parameter in a consumption system database that stores the at least one piece of consumption information. It may be understood that the more similar the consumption information is, the higher the matching degree may be. Therefore, the matching degree may be compared with a matching threshold to verify the at least one piece of consumption information. If all the matching degrees are greater than the corresponding matching thresholds, the consumption information may be authentic, and the verification may be successful; otherwise, the consumption information may be inauthentic and the verification may fail. The consumption parameter may include but not limited to a consumption time, a consumption location, a consumption category, a consumption duration, an amount of the fee, or the like, or a combination thereof. Different consumption parameters may be used for the verification of different consumption information, thus improving the accuracy of the verification. For instance, for consumption information related to a transportation service, the consumption time and the consumption duration may be selected for the verification of the consumption information. As another example, for consumption information related to an accommodation service, the consumption location and the consumption duration may be selected for the verification of the consumption information.

In some embodiments, the consumption system database may be implemented on a storage device, such as the storage device 140 of the payment management system 100. In some embodiments, the consumption system database may include the at least one piece of consumption information, prescribed information related to the service provided to the second user, the consumption evidence, or the like, or any combination thereof. For example, the prescribed information related to the service provided to the second user may be prescribed by the administrator, which may include but not limited to a prescribed location (e.g., a destination) for a business trip, a prescribed duration for a transportation means (e.g., the train), a prescribed time (e.g., departure time) for a transportation means, etc. In some embodiments, a reference parameter may be determined based on the prescribed information or the consumption evidence related to the service provided to the second user. The matching degree between a consumption parameter and a reference consumption parameter may be determined.

In some embodiments, the verification of the at least one piece of consumption information may be performed in a manner similar to the process 700, the process 800, and the process 900 shown in FIGS. 7-9, respectively. The matching degrees related to different consumption parameters may correspond to different matching thresholds. For example, the matching degree associated with the consumption location may be determined based on the first geographical information of a service provider and the second geographical information that indicates a position where the service is provided to the second user. Specifically, the matching degree related to the consumption location may be determined based on a similarity between a first character string related to the first geographical information (e.g., the address) and a second character string related to the second geographical information. The matching degree threshold for the matching degree determined based on the similarity between the first character string and the second character string may be, for example, 0.40, 0.45, 0.50, etc. Alternatively, the matching degree related to the consumption location may be determined based on an overlapping ratio between a first region related to the first geographical information and a second region related to the second geographical information. For instance, the matching degree threshold may be 0.50, 0.55, 0.60, etc.

FIG. 16 is a schematic diagram illustrating a fee payment management system according to some exemplary embodiments of the present disclosure. In some embodiments, the fee payment management system 1600 may be implemented on the processing engine 112. The processing engine 112 may be in communication with a storage medium (e.g., the storage device 140 of the payment management system 100, and/or the storage 390 of the terminal device 300), and may execute instructions stored in the storage medium. For instance, the payment management system 1600 may be configured to perform the process 1200, 1300, 1400, and/or 1500 shown in FIGS. 12-15, respectively. As shown in FIG. 16, a fee payment management system 1600 may include:

a request receiving unit 1610, configured to receive a fee payment request related to the second user initiated by the first user;

an information verification unit 1620, configured to determine at least one piece of consumption information corresponding to the fee payment request and verify the at least one piece of consumption information;

a proxy verification unit 1630, configured to verify whether the first user is authorized to initiate a fee payment request on behalf of the second user; and

an execution unit 1640, configured to allocate, after the at least one piece of consumption information and whether the first user is authorized to initiate the fee payment request related to the second user are successfully verified, the fee corresponding to the at least one piece of consumption information to the account of the second user based on the fee payment request.

In some embodiments, the request receiving unit 1610 may be configured to receive a fee payment request related to the second user initiated by the first user. The information verification unit 1620 may be configured to determine at least one piece of consumption information corresponding to the fee payment request and verify the at least one piece of consumption information, thereby preventing a payment for nonexistent consumption and avoiding a property loss. The proxy verification unit 1630 may be configured to verify whether the first user is authorized to initiate a fee payment request on behalf of the second user. After the at least one piece of consumption information and whether the first user is authorized to initiate the fee payment request related to the second user are successfully verified, the execution unit 408 may allocate a fee corresponding to the consumption information based on the fee payment request to the account of the second user. It may be understood that the account corresponding to the second user may be a bank account, or a third party account such as an account of WeChat wallet, Alipay, PayPal, or the like. It should be noted that the proxy on behalf of the second user (i.e., the first user) may not be allowed to give an instruction to change the account for receiving the payment, so as to ensure the security of the payment.

As used herein, the second user refers to a person who generates the consumption information (i.e., a person to whom the service is provided), and the first user refers to a person that is authorized by the second user, also referred to as a proxy of the second user. In order to reduce the repetitiveness of the process, the second user (i.e., the person who generates the consumption information) may designate one or more first users to be a proxy, and the one or more first users may deal with the reimbursement process on behalf of the second user who generates the consumption. It should be noted that the first user of the proxy may not be allowed to give an instruction to change the account for receiving the fee related to the fee payment request, so as to ensure the security of the payment.

In addition, it may be understood that there may be multiple pieces of consumption information in a fee payment request, and different consumption information may correspond to different second users. Moreover, the first user(s) designated by each second user may be independent. In some embodiments, more than one second user may designate the same first user as a proxy for initiating the fee payment request. Therefore, the first user, as a proxy, may perform the fee payment procedures for multiple second users.

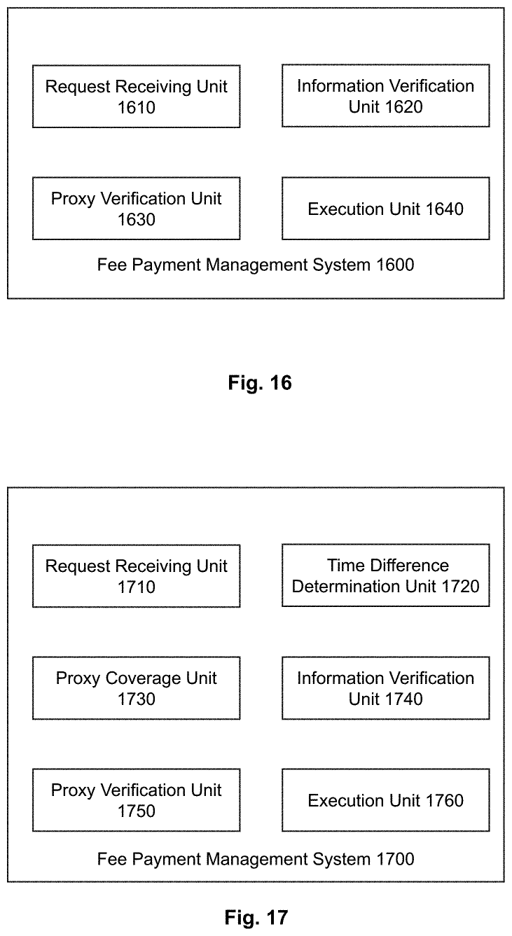

FIG. 17 is a schematic diagram illustrating a fee payment management system according to some exemplary embodiments of the present disclosure. In some embodiments, the fee payment management system 1700 may be implemented on the processing engine 112. The processing engine 112 may be in communication with a storage medium (e.g., the storage device 140 of the payment management system 100, and/or the storage 390 of the terminal device 300), and may execute instructions stored in the storage medium. For instance, the payment management system 1700 may be configured to perform the process 1200, 1300, 1400, and/or 1500 shown in FIGS. 12-15, respectively. As shown in FIG. 17, a fee payment management system 1700 may include:

a request receiving unit 1710, configured to receive a fee payment request related to the second user initiated by the first user;

a time difference determination unit 1720, configured to determine a time difference between a time point when the fee payment request initiated by the first user (i.e., the first payment request) is received and a time point when a fee payment request initiated by the second user (i.e., the first payment request) is received;

a proxy coverage unit 1730 configured to determine at least one piece of consumption information based on the fee payment request initiated by the second user if the time difference is not greater than the preset time length;

an information verification unit 1740, configured to verify the at least one piece of consumption information;

a proxy verification unit 1750, configured to verify whether the first user is authorized to initiate a fee payment request on behalf of the second user; and

an execution unit 1760, configured to allocate the fee corresponding to the at least one piece of consumption information to an account of the second user based on the fee payment request after the at least one piece of consumption information and whether the first user is authorized to initiate the fee payment request related to the second user are successfully verified.

In some embodiments, the request receiving unit 1710 may receive a fee payment request related to the second user initiated by the first user. The time difference determination unit 1720 may determine a time difference between a time point when the fee payment request initiated by the first user is received and a time point when a fee payment request initiated by the second user is received. If the time difference between the second user and the first user is not greater than the preset time length, the proxy coverage unit 1730 may determine the at least one piece of consumption information based on the fee payment request initiated by the second user. At this time, the fee payment request may be controlled by the second user, thereby ensuring the security of the payment. The information verification unit 1740 may verify the at least one piece of consumption information, thereby preventing a payment of non-existent consumption and avoiding a property loss. The proxy verification unit 1750 may be configured to verify whether the first user is authorized to initiate a fee payment request on behalf of the second user. After the at least one piece of consumption information and whether the first user is authorized to initiate the fee payment request related to the second user are successfully verified, the execution unit 1760 may allocate the fee corresponding to the at least one piece of consumption information to an account of the second user based on the fee payment request. Thus, the fee payment process may be completed. It may be understood that the account corresponding to the second user may be a bank account, or a third-party electronic account such as an account of the WeChat wallet, Alipay, PayPal, or the like.

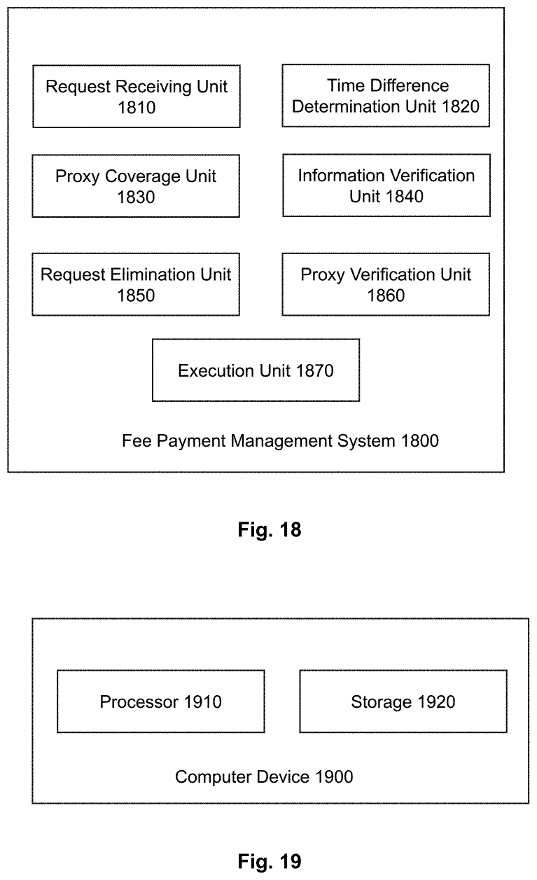

FIG. 18 is a schematic diagram illustrating a fee payment management system according to some exemplary embodiments of the present disclosure. In some embodiments, the fee payment management system 1800 may be implemented on the processing engine 112. The processing engine 112 may be in communication with a storage medium (e.g., the storage device 140 of the payment management system 100, and/or the storage 390 of the terminal device 300), and may execute instructions stored in the storage medium. For instance, the payment management system 1800 may be configured to perform the process 1200, 1300, 1400, and/or 1500 shown in FIGS. 12-15, respectively.

As shown in FIG. 18, a fee payment management system 1800 may include:

a request receiving unit 1810, configured to receive a fee payment request related to the second user initiated by the first user;

a time difference determination unit 1820, configured to determine a time difference between a time point when the fee payment request initiated by the first user (i.e., the first payment request) is received and a time point when a fee payment request initiated by the second user (i.e., the first payment request) is received;

a proxy coverage unit 1830, configured to determine at least one piece of consumption information based on the fee payment request initiated by the second user if the time difference is not greater than the preset time length;

an information verification unit 1840, configured to verify the at least one piece of consumption information;

a request elimination unit 1850, configured to delete the information of the at least one first user corresponding to the second user and the fee payment request of the at least one first user after the at least one piece of consumption information and whether the first user is authorized to initiate the fee payment request related to the second user are successfully verified;

a proxy verification unit 1860, configured to verify whether the first user is authorized to initiate a fee payment request on behalf of the second user; and

an execution unit 1870, configured to allocate the fee corresponding to the at least one piece of consumption information to an account of the second user based on the fee payment request after the at least one piece of consumption information and whether the first user is authorized to initiate the fee payment request related to the second user are successfully verified.

In some embodiments, the request receiving unit 1810 may receive a fee payment request related to the second user initiated by the first user. The time difference determination unit 1820 may determine a time difference between a time point when the fee payment request initiated by the first user is received and a time point when a fee payment request initiated by the second user is received. When the time difference between the second user and the first user is not greater than the preset time length, the proxy coverage unit 1830 may determine the at least one piece of consumption information based on the fee payment request initiated by the second user. At this time, the fee payment request may be controlled by the second user, thereby ensuring the security of the payment. The information verification unit 1840 may verify the at least one piece of consumption information, thereby preventing a payment of non-existent consumption and avoiding a property loss. The proxy verification unit 1860 may be configured to verify whether the first user is authorized to initiate a fee payment request on behalf of the second user. After the at least one piece of consumption information and whether the first user is authorized to initiate the fee payment request related to the second user are successfully verified, the request elimination unit 1850 may delete the information of the at least one first user corresponding to the second user and the fee payment request of the at least one first user. At this time, only the second user may have the right to modify the fee payment request, thus reducing the possibility that the fee of the second user is encroached by the first user, and increasing the security of the fee payment process. The execution unit 1860 may allocate the fee corresponding to the at least one piece of consumption information to an account of the second user based on the fee payment request. Thus, the fee payment process may be completed. It may be understood that the account corresponding to the second user may be a bank account, or a third-party electronic account such as an account of the WeChat wallet, Alipay, PayPal, or the like.

Specifically, the information verification unit 1840 may further include: a parameter matching unit, configured to determine at least one consumption parameter related to the consumption information, and determine a matching degree of each consumption parameter based on a consumption system database storing the consumption information; and a comparison unit, configured to compare the matching degree of each consumption parameter with a corresponding matching degree threshold, and determine that the verification is successful when all the matching degrees are greater than the corresponding matching thresholds; otherwise, the verification may fail. The consumption parameter may include but not limited to a consumption time, a consumption location, a consumption category, a consumption duration, an amount of the fee, or the like, or a combination thereof.

In some embodiments, the parameter matching unit may determine at least one consumption parameter related to the consumption information, and determine a matching degree of each consumption parameter based on a consumption system database storing the consumption information. It may be understood that the more similar the consumption information is, the higher the matching degree may be. Therefore, the matching degree may be compared with a matching threshold to verify the at least one piece of consumption information. The comparison unit can compare the matching degree of each obtained consumption parameter with the corresponding matching threshold. If all the matching degrees are greater than the corresponding matching thresholds, the consumption information may be authentic, and the verification may be successful; otherwise, the consumption information may be inauthentic and the verification may fail. The consumption parameter may include but not limited to a consumption time, a consumption location, a consumption category, a consumption duration, an amount of the fee, or the like, or a combination thereof. Different consumption parameters may be used for the verification of different consumption information, thus improving the accuracy of the verification.

FIG. 19 is a schematic diagram illustrating a computing device according to some exemplary embodiments of the present disclosure. FIG. 19 is a schematic diagram of the structure of a computing device according to some exemplary embodiments of the present disclosure.

As shown in FIG. 19, a computing device 1900 may include a processor 1910 and a storage 1920. The storage 1920 may store a computer program executable by a processor. When executing the computer program, the processor 1910 may implement the method for fee payment management of a fore-mentioned embodiment.

In some embodiments, when the processor 1910 of the computing device executes the computer program in the storage 1920, the method for fee payment management in any of the fore-mentioned embodiments may be implemented. Thus, a standardized management of the fee payment process may be realized, which may make the fee payment for reimbursement more convenient and improve the security of the payment.

The present disclosure also proposes a computer readable storage medium storing a computer program that, when executed by a processor, implements the method for fee payment management of any of the embodiments.

In some embodiments, when the computer program in the computer readable medium is executed by the processor, the method for fee payment management in any of the embodiments may be implemented, and the standardized management of the fee payment process may be realized. This may make the fee payment for reimbursement more convenient and improve the security of the payment.

The process for fee payment management provided by the present disclosure is described in detail above with reference to the accompanying drawings. In the process, at least one piece of consumption information corresponding to the fee payment request may be verified, thereby ensuring the authenticity of the consumption information and preventing the payment expense from being erroneously paid. The process also include verifying the eligibility of the proxy of the fee payment request to ensure that the first user has the qualification to represent the second user, which may improve the labor efficiency and reduce the possibility that the fee of the second user is encroached by the first user. The process of fee payment for reimbursement may be more standardized, making the fee payment for reimbursement more convenient and improve the security of the payment.

It should be noted that the above description regarding FIGS. 14-19 is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-20. (canceled)

21. A system, comprising:
at least one storage medium including a set of instructions; and
at least one processor in communication with the at least one storage medium, wherein when executing the instructions, the at least one processor is configured to direct the system to perform operations including:
receiving a payment request including information related to a service provided by a service provider, the information related to the service including first geographical information of the service provider;
obtaining second geographical information of a location where the service is provided;
comparing the first geographical information and the second geographical information; and
determining whether the payment request is approved according to a preset rule at least based on the result of the comparison of the two geographical information.

22. The system of claim 21, wherein the service is paid for by the user via a terminal device, and the second geographical information is generated by a positioning transceiver component of the terminal device.

23-24. (canceled)

25. The system of claim 21, wherein the first geographical information includes a first character string, and the second geographical information includes a second character string, and
wherein to determine whether the payment request is approved according to the preset rule at least based on the result of the comparison of the two geographical information, the at least one processor is configured to direct the system to perform additional operations including:
determining a similarity between the first character string and the second character string.

26. The system of claim 25, wherein the preset rule includes:
in response to a determination that the similarity between the first character string and the second character string exceeds a similarity threshold,
determining that the payment request is approved.

27. The system of claim 21, wherein the first geographical information includes a first geographical location, and the second geographical information includes a second geographical location, and
wherein to determine whether the payment request is approved according to the preset rule at least based on the result of the comparison of the two geographical information, the at least one processor is configured to direct the system to perform additional operations including:
determining a correlation between the first geographical location and the second geographical location.

28. The system of claim 27, wherein to determine whether the payment request is approved according to the preset rule at least based on the result of the comparison of the two geographical information, the at least one processor is configured to direct the system to perform additional operations including:
determining a first region including the first geographical location and a second region including the second geographical location; and
determining the correlation between the first geographical location and the second geographical location based on an overlap between the first region and the second region.

29. The system of claim 28, wherein the preset rule includes:
comparing the overlap between the first region and the second region with an overlap threshold;
in response to the result of the comparison that the overlap between the first region and the second region exceeds an overlap threshold,
determining that the payment request is approved.

30. The system of claim 21, wherein to determine whether the payment request is approved according to the preset rule at least based on the result of the comparison of the two geographical information, the at least one processor is configured to direct the system to perform additional operations including:
determining a time duration related to the service.

31. The system of claim 30, wherein the preset rule includes:
comparing the time duration related to the service with a time threshold;
in response to the result of the comparison that the time duration related to the service exceeds a time threshold,
determining that the payment request is approved.

32. The system of claim 21, wherein the payment request is encrypted, and the at least one processor is further configured to direct the system to perform additional operations including:
decrypting the payment request.

33-46. (canceled)

47. A system, comprising:
at least one storage medium including a set of instructions; and
at least one processor in communication with the at least one storage medium, wherein when executing the instructions, the at least one processor is configured to direct the system to perform operations including:
receiving a first payment request initiated by a first user, the first payment request being related to a service provided to a second user;
collecting first information related to the service provided to the second user;
generating a first verification result by verifying the first information according to a first preset rule;
generating a second verification result by verifying whether the first user is authorized to initiate the first payment request according to a second preset rule; and;
determining whether the first payment request is approved at least based on the first verification result and the second verification result.

48. The system of claim 47, wherein to generate the second verification result by verifying whether the first user is authorized to initiate the first payment request according to a second preset rule, the at least one processor is configured to direct the system to perform additional operations including:
receiving a second payment request initiated by the second user, the second payment request being related to the service provided to the second user;
collecting second information related to the second service; and
determining a time difference between a first time point associated with the first payment request and a second time point associated with the second payment request;
determining whether the time difference is less than or equal to a preset time; and
in response to a determination that the time difference is less than the preset time,
verifying that the first user is unauthorized to initiate the first payment request.

49. The system of claim 48, wherein the at least one processor is configured to direct the system to perform additional operations including:
deleting information of the first payment request.

50. The system of claim 48, wherein the at least one processor is configured to direct the system to perform additional operations including:
generating a third verification result by verifying the second information according to a third preset rule;
determining whether the second payment request is approved at least based on the third verification result.

51. The system of claim 50, wherein to generate the third verification result by verifying the second information according to the third preset rule, the at least one processor is configured to direct the system to perform additional operations including:
determining one or more second parameters based on the second information;
determining one or more second matching degrees associated with the one or more second parameters;
comparing the one or more second matching degrees with one or more second matching degree thresholds;
in response to a result of the comparison that the one or more second matching degrees are greater than the one or more second matching degree thresholds,
generating the third verification result that the second information is verified to be eligible.

52. The system of claim 51, wherein to generate the first verification result by verifying the first information according to the first preset rule, the at least one processor is configured to direct the system to perform additional operations including:
determining one or more first parameters based on the first information;
determining one or more first matching degrees associated with the one or more first parameters;
comparing the one or more first matching degrees with one or more first matching degree thresholds;
in response to a result of the comparison that the one or more first matching degrees are greater than the one or more first matching degree thresholds,
generating the first verification result that the first information is verified to be eligible.

53. The system of claim 52, wherein at least one of the one or more first parameters or the one or more second parameters includes at least one of a location related to the service provided to the second user, a time when the service is provided to the second user, a time duration related to the service provided to the second user, or a category of the service provided to the second user.

54. The system of claim 53, wherein the at least one processor is configured to direct the system to perform additional operations including:
determining first geographical information of a service provider that provides the service to the second user;
determining second geographical information of a location where the service is provided to the second user; and
determining, based on the first geographical information and the second geographical information, at least one of the one or more first matching degrees or the one or more second matching degrees.

55-56. (canceled)

57. The system of claim 53, wherein the at least one processor is configured to direct the system to perform additional operations including:
determining a time duration related to the service provided to the second user;
determining, based on the time duration and a preset time duration, the at least one of the one or more first matching degrees or the one or more second matching degrees.

58. A method implemented on a computing device having at least one processor and at least one non-transitory storage medium, the method comprising:
receiving a first payment request initiated by a first user, the first payment request being related to a service provided to a second user;
collecting first information related to the service provided to the second user;
generating a first verification result by verifying the first information according to a first preset rule;
generating a second verification result by verifying whether the first user is authorized to initiate the first payment request according to a second preset rule; and;
determining whether the first payment request is approved at least based on the first verification result and the second verification result.

59-70. (canceled)
